(19) United States
(12) Patent Application Publication
(10) Pub. No.: US 2011/0301978 A1
(43) Pub. Date: Dec. 8, 2011

(54) SYSTEMS AND METHODS FOR MANAGING PATIENT MEDICAL INFORMATION

(76) Inventors: Patrick Shiu, Vancouver (CA); Teddie Shiu, Markham (CA)

(21) Appl. No.: 12/793,882

(22) Filed: Jun. 4, 2010

(51) Int. Cl. G06Q 50/00; G06Q 30/00; G06Q 10/00

(52) U.S. Cl. 705/3

(57) ABSTRACT

Methods and systems for managing patient medical information are provided in order to make it more convenient for patient information to be managed both electronically and using traditional physical files. The methods and systems comprise: storing patient medical information in an electronic patient record; generating at least one adhesive medical summary corresponding to the patient medical information; and, affixing the adhesive medical summary to a physical patient record. An electronic patient record may be stored in a database and may comprise general patient identifier information, patient assessment or medical examination information, patient prescription information, and/or immunization information. The methods and systems may also comprise billing information that may be used to generate billing summaries. Medical condition templates comprising default medical assessment information as typically determined for a specific medical condition may be used to facilitate the entry of patient medical information.

### TECHNICAL FIELD

Embodiments described herein relate generally to the management of patient information, and more specifically to systems and methods for managing medical records.

### BACKGROUND

Traditionally, patient information has been recorded on paper and stored in file folders in medical offices, hospitals and the like. This places the information at risk of accidental or catastrophic loss. Furthermore, the legibility of handwritten medical files and prescriptions may be problematic.

Electronic patient information systems have also been developed. However, the physical patient file remains a standard part of many medical practices. Accordingly, the inventor has recognized a need for improved systems and methods for storing patient information.

### BRIEF DESCRIPTION OF THE DRAWINGS

For a better understanding of the example embodiments described herein, and to show more clearly how they may be carried into effect, reference will now be made, by way of example, to the accompanying drawings in which:

FIG. 1 is a block diagram of an information management system for patient medical information in one example implementation.

FIG. 2 is a flowchart illustrating steps of a method of managing patient information in accordance with at least one embodiment.

FIG. 3 is a schematic illustration of example general patient information records containing exemplary data as may be stored in the patient database of FIG. 1.

FIG. 4 is a schematic illustration of example patient assessment records containing exemplary data as may be stored in the patient database of FIG. 1.

FIG. 5 is a schematic illustration of example assessment history records containing exemplary data as may be stored in the patient database of FIG. 1.

FIG. 6 is a schematic illustration of example patient prescription records containing exemplary data as may be stored in the patient database of FIG. 1.

FIG. 7 is a schematic illustration of example patient billing records containing exemplary data as may be stored in the patient database of FIG. 1.

FIG. 8 is a schematic illustration of example assessment template records containing exemplary data as may be stored in the medical database of FIG. 1.

FIG. 9 is a schematic illustration of example prescription template records containing exemplary data as may be stored in the prescription database of FIG. 1.

FIG. 10 is a schematic illustration of example billing code records containing exemplary data as may be stored in the billing database of FIG. 1.

FIG. 11 is an illustration of a physical patient record as may be stored in the physical patient record storage of FIG. 1.

FIG. 12 is an example screen shot displaying aspects of patient, prescription and billing information as may be stored, generated and displayed by the system of FIG. 1.

FIG. 13 is an example screen shot of an initial medical assessment summary as may be generated and displayed by the system of FIG. 1.

FIG. 14 is an example screen shot of an initial prescription summary as may be generated and displayed by the system of FIG. 1.

FIG. 15 is an example screen shot of an initial prescription as may be generated by the system of FIG. 1.

FIG. 16 is an example screen shot of a billing summary as may be generated and displayed by the system of FIG. 1.

FIG. 17 is an example screen shot of a completed medical assessment summary as may be generated and displayed by the system of FIG.

FIG. 18 is an example screen shot of a completed prescription summary as may be generated and displayed by the system of FIG. 1.

### DETAILED DESCRIPTION

Embodiments described herein are generally directed to methods and systems for managing patient medical information. In order to make it more convenient for patient information to be managed both electronically and using traditional physical files the embodiments discussed herein generally relate to hybrid, or electronic and physical, methods and systems for managing patient information. Some embodiments of the invention may be implemented for a specific site or office location. Alternatively, some embodiments may be implemented as a shared system between multiple sites or office locations using a network or other communication methods and/or centralized physical filing systems.

In a first broad aspect, at least one embodiment described herein is directed towards a method for managing patient information. The method includes the steps of: storing patient medical information in an electronic patient record; generating at least one adhesive medical summary corresponding to the patient medical information; and, affixing the adhesive medical summary to a physical patient record. An electronic patient record may include general patient identifier information, patient assessment or medical examination information, patient prescription information, and/or immunization information. An adhesive medical summary may include an adhesive medical history summary, an adhesive medical assessment summary, an adhesive prescription summary and/or an adhesive immunization summary. Additionally, the method may involve storing the electronic patient records in a database. Furthermore, the adhesive medical summary may include current or historical medical condition information.

In some instances, generating the adhesive medical summary may include printing the adhesive medical summary. Furthermore, the physical patient record may comprise a physical file folder, binder and/or set of at least one paper record. Additionally, the physical patent record may be stored in a physical file management system, for example, a filing cabinet.

Determining the patient medical information to be stored in an electronic patient record may include acquiring the information through an assessment of the patient. In some instances, the assessment of a patient may involve an examination of the patient. Examination may include questioning, visual examination, and/or physical examination of the patient. Furthermore, the assessment or examination may take place at a location remote from the storage location of the electronic and/or physical patient records.

In at least some implementations, the method may include generating a billing summary corresponding to at least some of the patient medical information stored in the electronic patient records. The billing information may also be stored in a database. In some instances, generating the billing summary may include printing the billing summary. Furthermore, the method may involve storing the generated billing report with the physical patient records. Alternatively, the generated billing report may be stored in a database and/or with the electronic patient records. In at least some embodiments, at least one billing summary may be submitted to insurance, non-governmental and/or governmental organizations in electronic and/or physical forms.

In some embodiments, the method may be directed towards storing a set of at least one medical condition template such that storing patient medical information in an electronic patient record involves selecting at least one medical condition template from the medical condition template set. Medical condition templates may be used to store default medical assessment information as typically determined for a specific medical condition. The medical condition templates in the medical condition template set may be stored in a database. In some instances, storing patient medical information may include modifying a medical condition template to correspond with the information obtained during an assessment or examination. In at least some embodiments, the modified medical condition template may be saved as a new medical condition template in the medical condition template set. Furthermore, medical condition templates may be removed from the medical condition template set or database.

The method of managing patient medical information may also include storing a set of at least one billing code, wherein at least one billing code in the billing code set corresponds to, or is associated with, at least one medical condition template from the medical condition template set. Billing codes in the billing code set may be stored in a database. In some instances, the association between a billing code and a medical condition template may be overridden or changed. Furthermore, the method may comprise adding or removing billing codes from the billing code set or database.

The method may further involve selecting a billing code corresponding to the patient medical information stored in the electronic patient records and generating a billing summary corresponding to the selected billing code and the corresponding patient medical information. In at least some embodiments, patient medical information is associated with at least one medical condition template and medical condition templates may correspond with at least one billing code. Patient medical information can therefore be associated with billing information and medical condition templates can be associated with default billing information.

The patient medical information stored in the electronic patient records may include at least one determined prescription. Additionally, assessment or examination of the patient may include determination of the required prescription information. In some implementations, the adhesive medical summary may comprise prescription information or an adhesive prescription summary.

The method may also involve generating at least one determined prescription. In some instances, the determined prescription information may be stored in a database. In at least some implementations, generation of the at least one determined prescription may include printing the prescription. Furthermore, the method may include storing the generated prescription with the physical patient records. Alternatively, the generated prescription may be stored in a database and/or with the electronic patient records. Additionally, the method may comprise providing a copy of the generated prescription to the patient, another responsible party or a third party. In at least some embodiments, the generated prescriptions may be submitted directly to third party suppliers, such as a pharmacy, in electronic and/or physical form.

In other implementations, the method may also comprise storing a set of at least one prescription template, wherein storing patient medical information in an electronic patient medical record includes selecting at least one prescription template from the prescription template set. The prescription templates in the prescription template set may be stored in a database. In some instances, storing patient medical information, or the determined prescription information, may involve modifying a prescription template to correspond with the information obtained during an assessment or examination. In at least some embodiments, a modified prescription template may be saved as a new prescription template in the prescription template set. Furthermore, prescription templates may be removed from the prescription template set or database.

Other embodiments of the method may include associating at least one prescription template in the prescription template set with at least one medical condition template in the medical condition template set. In some instances the association, or correspondence, between a prescription template and a medical condition template may be overridden or changed. Furthermore, the method may include adding or removing prescription templates from the prescription template set or database. In at least some embodiments, patient medical information is associated with at least one medical condition template and medical condition templates may be associated with prescription templates. As such, medical condition templates can be associated with default prescription information.

In a second broad aspect of the invention, at least one embodiment described herein is directed towards a physical patient record produced using any of the methods or embodiments described above.

In a third broad aspect of the invention, at least one embodiment described herein is directed towards a system for managing patient medical information. The system includes an electronic patient record database and a medical summary generator operatively coupled to the electronic patient record database. The electronic patient record database includes at least one electronic patient record containing patient medical information. The medical summary generator is configured to generate at least one adhesive medical summary corresponding to the patient medical information. In at least some embodiments, the adhesive medical summaries may be printed by a printer or label generator operatively coupled to the medical summary generator through a network or other communication means.

In at least some implementations, the system may comprise at least one physical patient record to which the at least one adhesive medical summary, as generated by the medical summary generator, may be affixed.

The system may also include a stored set of at least one medical condition template, wherein each medical condition template in the medical condition template set may be used to input patient assessment information. Additionally, the system may include one or more devices for inputting patient medical assessment information, such as a computer terminal, operatively connected to the patient database.

In some instances, the system may also comprise a stored set of at least one billing code. Additionally, the system may include a billing generator operatively coupled to the electronic patient record database. The billing generator may be configured to generate billing summaries corresponding to patient medical information. Furthermore, the billing generator may be configured to generate billing records corresponding to at least one billing code in the billing code set. The system may also include a printer operatively connected to the billing generator and configured to print billing summaries. Additionally, at least one billing code in the billing code set may correspond to, or may be associated with, at least one medical condition template.

The patient medical information stored by the system may include at least one determined prescription. The system may also include a prescription generator operatively coupled to the electronic patient record database and configured to generate the at least one determined prescription. Additionally, the system may comprise a printer operatively connected to the prescription generator and configured to print at least one determined prescription.

The system may additionally include a stored set of at least one prescription template, wherein each prescription template in the prescription template set may be used to input patient medical information. Furthermore, at least one prescription template in the prescription template set may correspond to, or may be associated with, at least one medical condition template in the medical condition template set.

These and other aspects and features of various embodiments will be described in greater detail below.

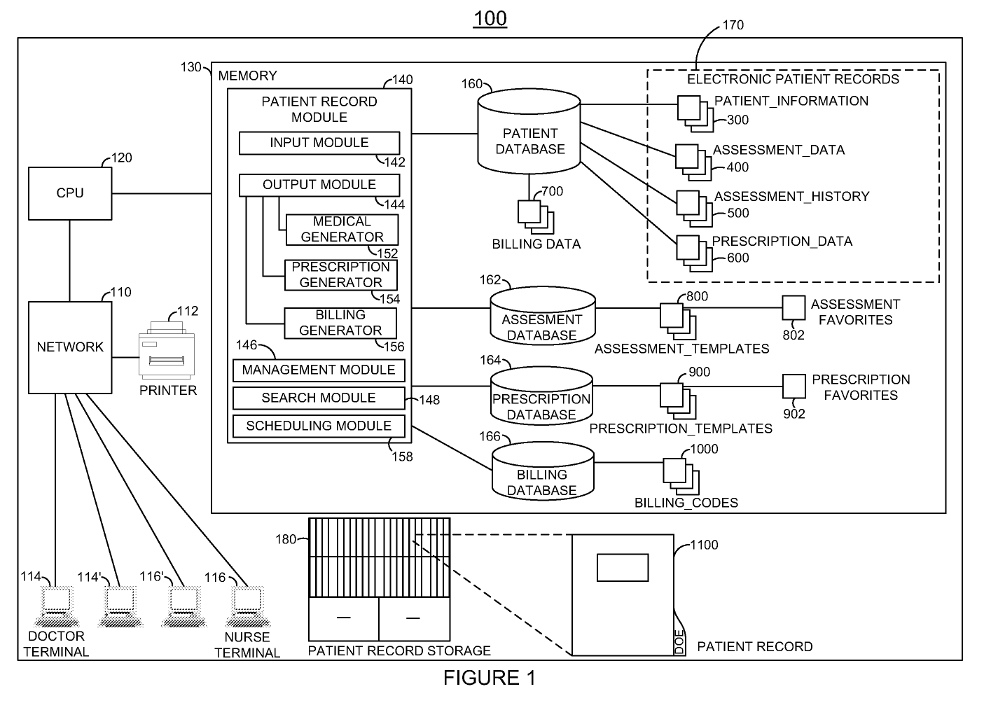

Referring first to FIG. 1, a block diagram of a system for managing patient medical information in one example implementation is shown generally as 100. System 100 comprises a number of components, including microprocessor or central processing unit (CPU) 120 which may form part of a computer system. CPU 120 controls the overall operation of component 130 of system 100. Microprocessor 120 also interacts with additional subsystems such as memory storage 130 (which may include random access memory (RAM) and read-only memory (ROM), and persistent storage such as flash memory, for example).

The microprocessor 120 is also operatively connected to numerous input and output devices via a network 110. The network 110 may incorporate or otherwise be operatively coupled to different types of networks (e.g. Local Area Networks (LANs), Wide Area Networks (WANs), the Internet), and may be wired (e.g. through an Ethernet, serial or Asynchronous Transfer Mode (ATM) connection) or wireless (e.g. through 802.11 Wireless Local Area Network (WLAN), or cellular standards), for example. The input and output devices connected to the network 110 may include a printer 112 (e.g. an ink jet, laser or thermo printing device). The system 100 may utilize more than one printer 112 and/or may use the network 110 to communicate with remote printing devices.

The network 110 may also be connected to input and output terminals such as doctor terminals 114 and nurse terminals 116, which may, for example, be in the form of desktops, laptops, or mobile computing devices. The terminals 114,116 may comprise a display device (e.g. a Liquid Crystal Display (LCD) or Organic Light Emitting Device (OLED) flat panel screen), which may be touch enabled to facilitate input. The terminals 114, 116 may also include other input devices operatively connected to the display (e.g. keyboard, mouse, card reader, touch pad). Furthermore, the terminals may comprise a CPU and memory as might be the case with a laptop, for example. The system 100 may use the network 110 to communicate with remote terminals shown generally as 114′ and 116′ (corresponding substantially to local terminals 114 and 116 respectively), which may be present at another location and/or which may be in the form of mobile devices. In alternate embodiments, the terminals 114, 114′, 116 and 116′ may comprise the CPU 120 and/or memory 130 allowing for local and/or distributed control of memory 130.

Operating system software used by CPU 120 is typically stored in a persistent store such as flash memory, ROM memory or similar storage element (not shown). Those skilled in the art will appreciate that the operating system, specific device applications, or parts thereof, may be temporarily loaded into a volatile store such as RAM. As well, the databases described herein may be implemented as remote databases that may be accessible across computer networks (including the Internet) through database server software. In further alternate embodiments, some or all of the software, hardware and databases described herein may be implemented remotely such that CPU 120 and some or all of system 100 may be in one geographical location, and users accessing the system 100 (e.g. through remote terminals 114′ and 116′ or through a web browser or a “thin” client) may be in another geographical location.

CPU 120, in addition to its operating system functions, enables execution of software applications which may include a patient record module program 140, typically stored in memory 130 and programmed to cause the CPU 120 to provide the functionality discussed herein. The system 100 may also include within the memory 130 a patient database 160, an assessment database 162, a prescription database 164 and a billing database 166. Patient database 160 may store electronic patient records 170 and billing data records 700. The electronic patient records 170 may be comprised of patient information records 300, assessment data records 400, assessment history records 500 and prescription data records 600. The assessment database 162 may comprise a set of medical assessment template records 800 which may include a subset of favorite assessment template records 802. The prescription database 164 may comprise a set of prescription template records 900 which may include a subset of favorite prescription template records 902. The billing database 166 may comprise a set of billing code records 1000. It will be understood by those skilled in the art that numerous methods for efficiently designing database tables and records may result in different arrangements of records and databases.

The patient record module program 140 may comprise an input module 142 operatively connected to input sources including the doctor terminals 114, 114′ and the nurse terminals 116,116′. These terminals 114, 114′, 116, 116′ permit users of the system 100 to input data and other information via the input module 142. Information entered by users may be stored in the databases described above in accordance with the methods and records described herein. The patient record module 140 may also comprise an output module 144. The output module may comprise one or more generators 152, 154, 156. For example, a medical generator 152 may be provided, which is configured to generate medical summaries. A prescription generator 154, which is configured to generate determined prescriptions, may also be provided. Further, a billing generator 156 may be provided, which is configured to generate billing summaries. The output module 144 may send information to any of the terminals 114, 114′, 116, 116′ or printer 112 (or elsewhere via Network 110) to which it is operatively connected. Information is sent to the terminals 114, 114′, 116, 116′ for display. Information sent to the printer 112 may be printed (e.g. on paper or adhesive labels). The patient record module 140 may also comprise a management module 146 that is operatively connected to the terminals 114, 114′ 116 and 116′ and configured to manage the relationships between database records 300, 400, 500, 600 700, 800, 900, 1000, for example. Furthermore, the patient record module 140 may comprise a search module 148 operatively connected to the terminals 114, 114′ 116 and 116′ and configured to facilitate searching for database records 300, 400, 500, 600 700, 800, 900, 1000, for example. Finally, the patient record module 140 may comprise a scheduling module 158 that is operatively connected to the terminals 114, 114′ 116 and 116′ and configured to facilitate the scheduling of patient appointments. As will be understood by those in the art, the database records 300, 400, 500, 600 700, 800, 900, 1000 described and illustrated herein are for example purposes only. Other tables, database records and organizational structures may be implemented in various embodiments of the system 100 and may be maintained and configured using, for example, management module 146.

System 100 also includes a physical patient record storage unit or area 180 for storing physical patient records 1100. For example, the patient record storage unit 180 may comprise a filing cabinet or shelf located at a medical office. The physical patient record 1100 may, for example, be in the form of a file folder, binder, or similar device designed to hold and store information relating to a particular patient. The information stored in a physical patient record 1100 may be generated in whole or in part by the printer 112. As will be understood by those skilled in the art, there are many possible ways of arranging and managing physical patient files in a physical filing system.

From a high level perspective, system 100 may be used to manage patient medical information. Information entered by a user at a terminal 114, 114′ or 116, 116′ may be processed, for example, by the input module 142 of the patient record module 140. The information entered may be saved in the databases 160, 162, 164 and 166 and electronic patient records 170 may, for example, be comprised of data in said databases. The output module 144 may be engaged to electronically and/or physically generate a medical summary, billing summary, immunization summary or prescription corresponding with data stored in the databases. The generated documents may be displayed to a user via the terminals 114, 114′, 116, 116′ by output module 144. The generated documents may also be physically produced by the printer 112. Once a physical document is generated by the printer 112 it may be inserted into a physical patient record 1100. In at least one embodiment, adhesive medical summaries generated by the printer 112 may be affixed to a physical patient record 1100. Similarly, billing summaries and prescriptions may be generated by printer 112 and inserted or attached to a physical patient record 1100. The physical patient record 1100 may be stored in the physical patient record storage unit 180.

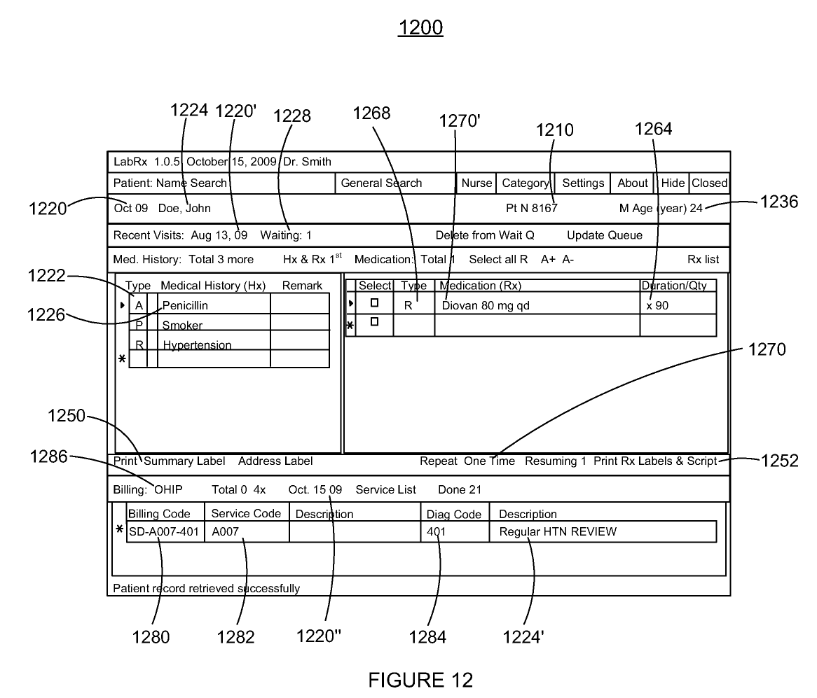

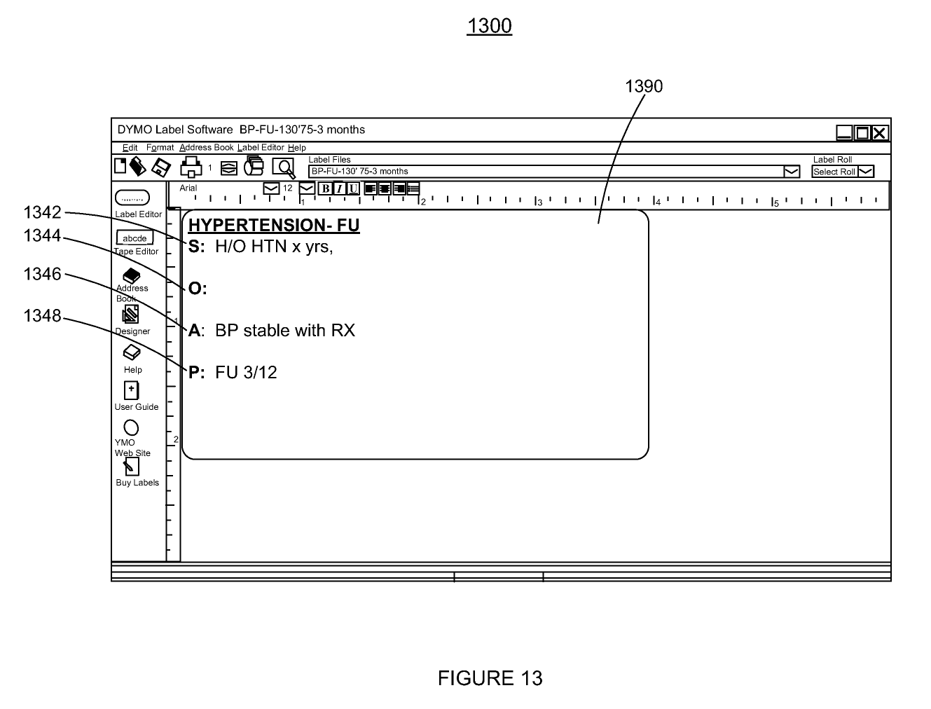

The terminals 114, 114′, 116 and 116′ may be used to display a variety of information as generated by, for example, the output module 144. Referring briefly to FIG. 12, the terminals 114, 114′, 116 and 116′ may display a screen such as that shown generally as 1200, for example. Referring briefly to FIGS. 13, 14 and 15, for example, the terminals 114, 114′, 116 and 116′ may display the exemplary screen shots shown generally as 1300, 1400 and 1500 respectively. As will be appreciated by those skilled in the art, the screen shots 1200, 1300, 1400 and 1500 are provided for example purposes only and are not meant to be limiting. Alternative embodiments of the system described herein may display other information (e.g. program screens, program features, database records) on, for example, terminals 114, 114′, 116 and 116′.

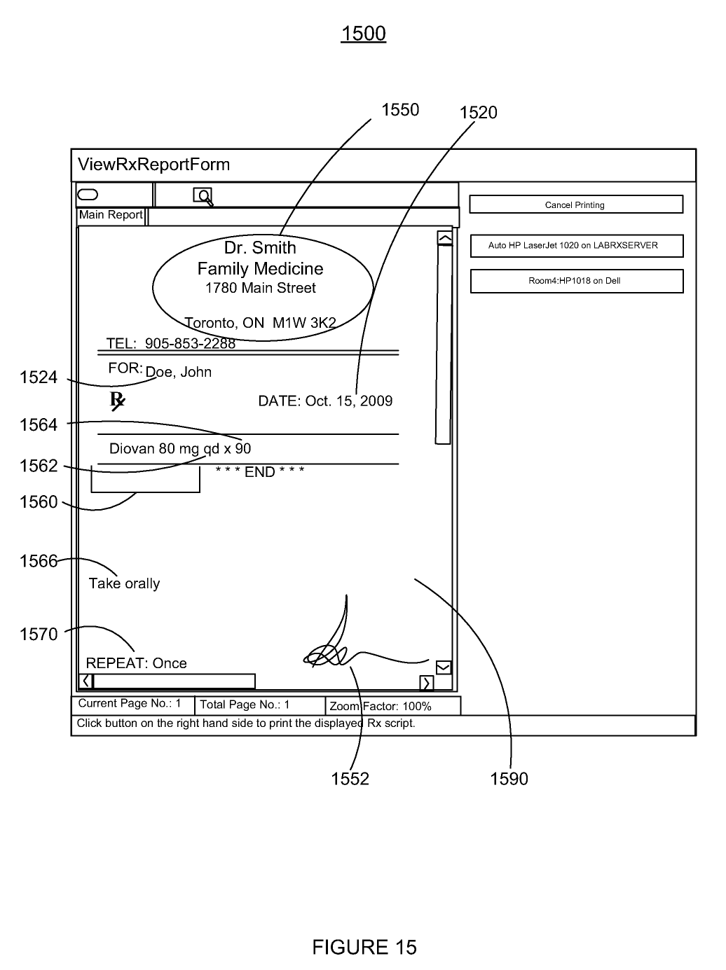

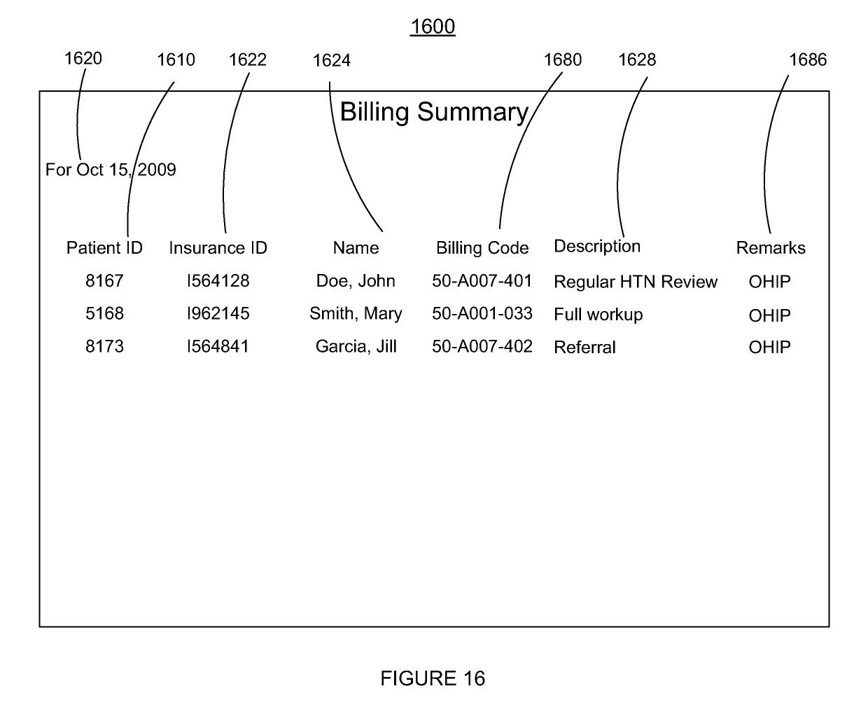

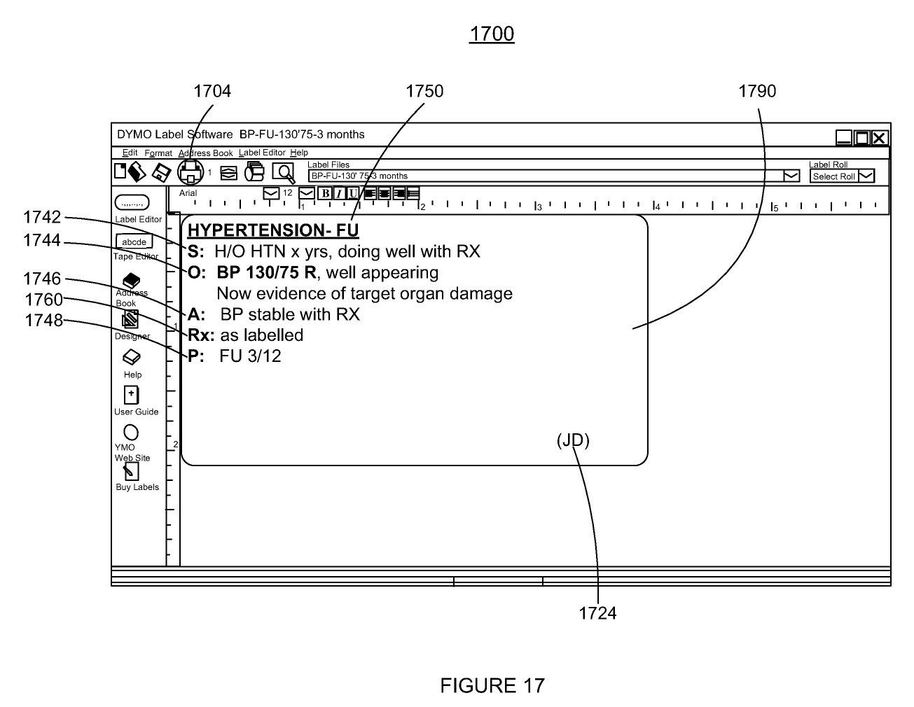

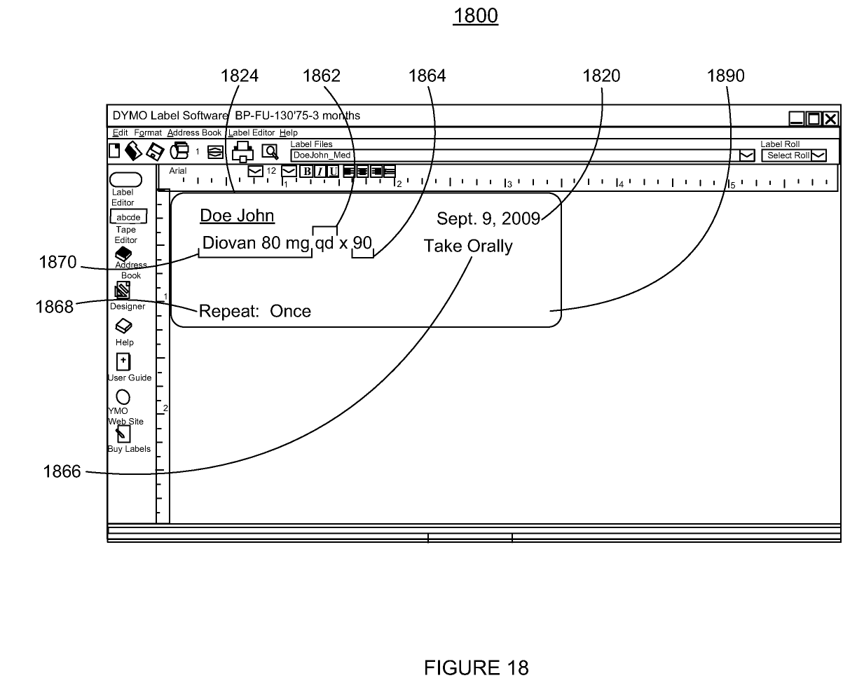

The printer 112 may be used to generate numerous documents and may be operatively coupled to medical generator 152, prescription generator 154 and/or billing generator 156. A single multi-purpose printer may be used to perform these tasks, or alternatively multiple printers may be used allowing for specialized printers or for increases in scalability. Referring briefly to FIG. 17 the printer 112 may print an adhesive medical assessment summary, one exemplary illustration of which is shown generally as 1790, as generated by the medical generator 152. Referring to FIG. 18, an adhesive prescription summary is shown generally as 1890, as generated by, for example, the medical generator 152. The printer 112 may also be used to generate the adhesive prescription summary 1890. Referring briefly to FIG. 15, the printer 112 may also generate a determined prescription, an example of which is shown generally as 1590. Finally referring briefly to FIG. 16, the printer 112 may be used to print a billing summary, such as that shown generally as 1600. It will be understood that the printer 112 may also be used to generate other documents and adhesive summaries.

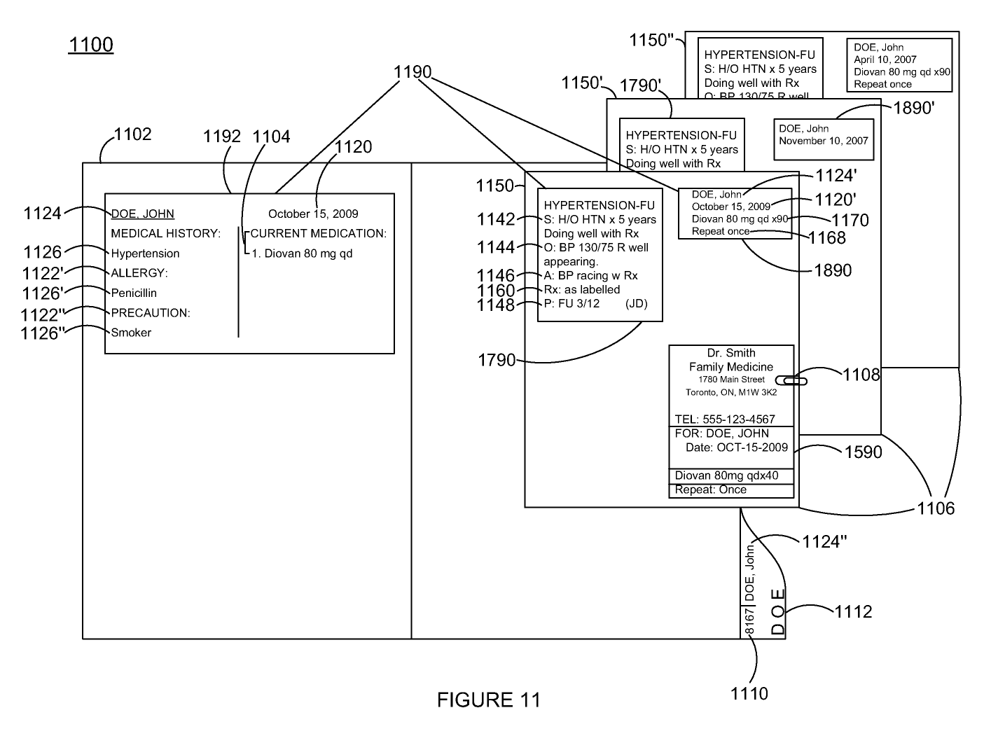

Referring briefly to FIG. 11 an adhesive medical summary shown generally as 1190 may comprise an adhesive medical history summary 1192, an adhesive medical assessment summary 1790, an adhesive prescription summary 1890 or an adhesive immunization summary (not shown). As will be appreciated by those skilled in the art the illustrated adhesive summaries 1190 (including 1192, 1790 and 1890) determined prescription 1590 and billing summary 1600 are provided for example purposes only and are not meant to be limiting. In alternative embodiments other documents or adhesive summaries may be generated and may contain more or less information than illustrated in the exemplary embodiments provided.

The generation of adhesive medical summaries 1190 by the printer 112 enables the electronic components (e.g. CPU 120, Memory 130, Patient Record Module 140 and Patient Database 160) and physical components (e.g. Patient Record Storage 180 and Patient Record 1100) of the patient information management system 100 to operate in concert with one another. As previously discussed, although electronic patient information systems have been developed the use of physical patient records has remained a standard part of many medical practices. The adhesive medical summaries 1190 may be used to bridge the gap between the use of physical patient records and wholly electronic patient medical information systems. The co-functioning or co-operative operation of electronic and physical patent medical information systems (e.g. hybrid medical information management systems) may have several advantages. For example, when compared with the use of only a physical patient record system or an electronic patient medical information system, a hybrid patient record management system with both electronic and physical records may have at least the following benefits: the ability to reproduce physical documents in the event physical records are lost or damaged (e.g. due to flood, fire or accidental loss); the ability to continue using physical records for patient and practice management (e.g. to manage a queue of waiting patients); the ability to maintain a centrally located physical record while electronic records may be maintained in remote and potentially disparate locations; compliance with regulations that require physical copies of patient records to be maintained; the ability to facilitate the transition from physical record management to electronic record management (e.g. by preserving a sense of familiarity through the use of physical records during a transition period); and, the ability to access physical records if and when electronic access is unavailable (e.g. as a result of an electrical failure or network connectivity problems). Furthermore, the legal consequences of losing electronic data as a result of a computer system failure, or having electronic data stolen are unclear. A physical copy of the information as facilitated by the use of adhesive medical summaries 1190 allows for the information to be traditionally secured and preserved.

In addition to the above noted systematic benefits, the use of adhesive medical summaries 1190, when affixed to physical patient records 1100, may present further advantages over handwritten patient records including at least the following: increased legibility of medical assessment information; consistency of appearance and structure of physical patient records 1100 (e.g. as enforced by the patient medical information system 100 through the formatting of adhesive summaries 1190); and, reduced paper consumption (e.g. as a consequence of the ability to affix multiple adhesive summaries 1190 to one page in a physical patient record 1100 where a medical practitioner might otherwise use one or more pages per patient visit). For example, in traditional electronic medical record systems patient information from an assessment may be printed on one sheet of paper whereas a user of system 100 may affix and arrange one or more adhesive medical summaries 1190 to one sheet of paper using a multitude of organizational systems (e.g. one organizational system is described further below with respect to FIG. 11).

Furthermore, adhesive medical summaries 1190 may permit a medical practitioner to increase the reliability, speed and transferability of their practice as compared to a medical practice that uses only physical patient records or an electronic patient medical information system. With respect to reliability, since the physical patient record 1100 may be more consistent in structure, appearance and legibility than a comparable handwritten record, a medical practitioner or his associates may more readily and accurately review a patient's medical history. These advantages may be most pronounced when a new or visiting medical practitioner must become familiar with a patient's medical history quickly based on the notes of another medical practitioner (e.g. when one doctor is covering for another). Furthermore, the use of electronic patient medical information systems alone may present several problems for new or visiting medical practitioners. First, there may be security features that complicate or prevent the use of electronic patient medical information systems as compared to physical patient records 1100. Second, although the format of physical patient medical records 1100 is generally standardized, as a consequence of their long historical use, the same is not necessarily true for electronic patient information systems which may have, for example, a variety of different user interfaces and features. This may result in a steep learning curve for users of electronic patient information systems and this may hamper the reliability of at least some medical practices. For example, there are known vendors of electronic patient information systems. A medical practitioner familiar with one vendor's product may be unable to navigate or effectively use a product from another vendor. However, all medical practitioners are generally capable of interpreting and using a physical patient record as exemplified by 1100.

The speed of a medical practice may also be enhanced for similar reasons to those discussed above with respect to reliability. However, speed may also be enhanced through increased data entry efficiency and delegation. Specifically, data entry using a terminal 114, 114′, 116, 116′ may be significantly faster than handwriting. Furthermore, once data entry has been performed, the actual management of the physical record 1100 may be delegated to assistants who may be responsible for printing and affixing adhesive medical summaries 1190 to the physical patient record 1100 and filing the records in the patient record storage 180.

The transferability of a practice may also be enhanced for similar reasons to those discussed above with respect to reliability. Specifically, by enhancing the legibility and consistency of physical patient records 1100 adhesive medical summaries 1190 may allow new medical practitioners to more easily review a patient's medical history effectively. Furthermore, many new medical graduates are demanding that medical records be stored electronically. Consequently, through the use of adhesive medical summaries 1190, established medical practitioners may preserve the familiarity of physical filing systems while also ensuring the long-term value and salability of their medical practice.

The use of adhesive medical summaries 1190 may also allow medical practitioners to more readily comply with the standards of other medical practices. For example, there is a wide variance in the form, shape, size and content requirements of requisition and referral forms for different medical practices such as clinics and specialist centers where medical procedures and consultations may be carried out. Many of these facilities are extremely particular about the format for such forms. Furthermore, many facilities do not accept electronic requisitions or forms. System 100 may be used to produce adhesive medical summaries 1190 comprising the requisite information which may be affixed to, for example, the referral or requisition forms of another practitioner or facility. These forms may then be transmitted to the other facility using, for example, a fax machine or other physical or electronic means.

The use of adhesive medical summaries 1190 and physical patient records 1100 also means that patients or medical practitioners may carefully control the availability and use of electronic medical records. For example, system 100 may allow patients or medical practitioners to select which data fields will be accessible or disclosed electronically and which will only be accessible in physical form (e.g. as adhesive medical summaries 1190 attached to a physical patient record 1100).

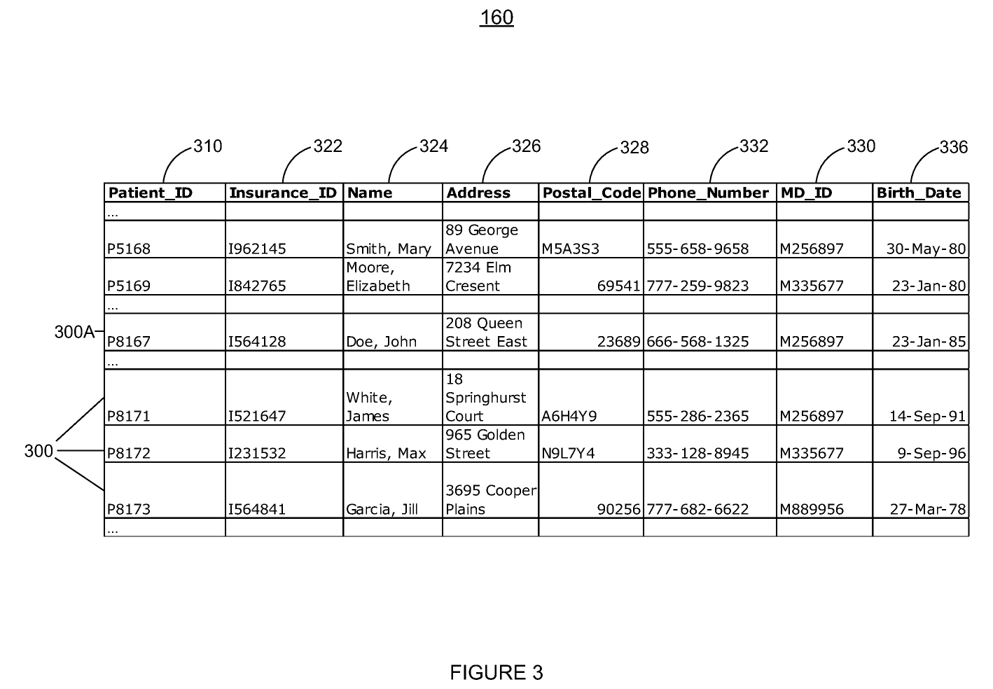

Reference will now be made to FIGS. 3 through 10 which illustrate example records containing exemplary data as may be stored in the databases shown in FIG. 1. As will be appreciated by those skilled in the art, the data structures and exemplary data records shown in FIGS. 3 through 10 are provided for example purposes only and are not to be construed as limiting. Variations to the types of data stored and the organizational structures used to store information in the system 100 are possible in alternative embodiments. Starting with FIG. 3 depicted therein is a schematic illustration of example patient information records 300 containing exemplary data as may be stored in the patient database 160. The data stored in the patient information records 300 is generally directed towards standard patient identification information and each record represents a different patient as stored in the system. A patient information record 300 may include a unique patient identifier 310 which in some instances may comprise a sequentially generated number or alphanumeric string produced by, for example, the management module 146 when a new patient is added to the patient database 160. This patient identifier may form the principle foreign key or link for other electronic records in the system. The data stored in a patient information record 300 may also comprise an insurance identifier 322 such as a government assigned health care code, or private insurance indicia. Further, the data stored in a patient information record 300 may typically comprise: the name of the patient 324; the patient's address 326 including for example, a separate field for the postal code 328; the patient's phone number 332; and, the patient's birth date 336. Finally, the data may also comprise a medical doctor identifier 330 that corresponds, for example, with the patient's principal, general practice or treating doctor. The medical doctor identifier may correspond to an internal, professional or governmentally assigned identifier. As will be appreciated by those skilled in the art, variations to the type of data and organizational structures used to store patient information in the patient information records 300 are possible and the examples described above are for illustration purposes only.

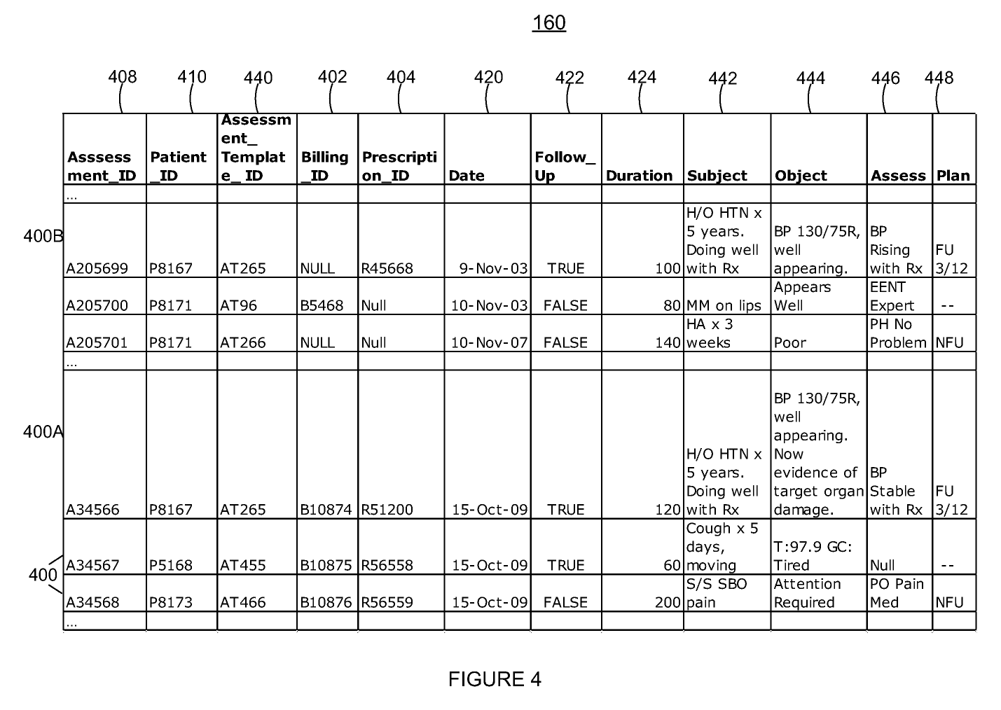

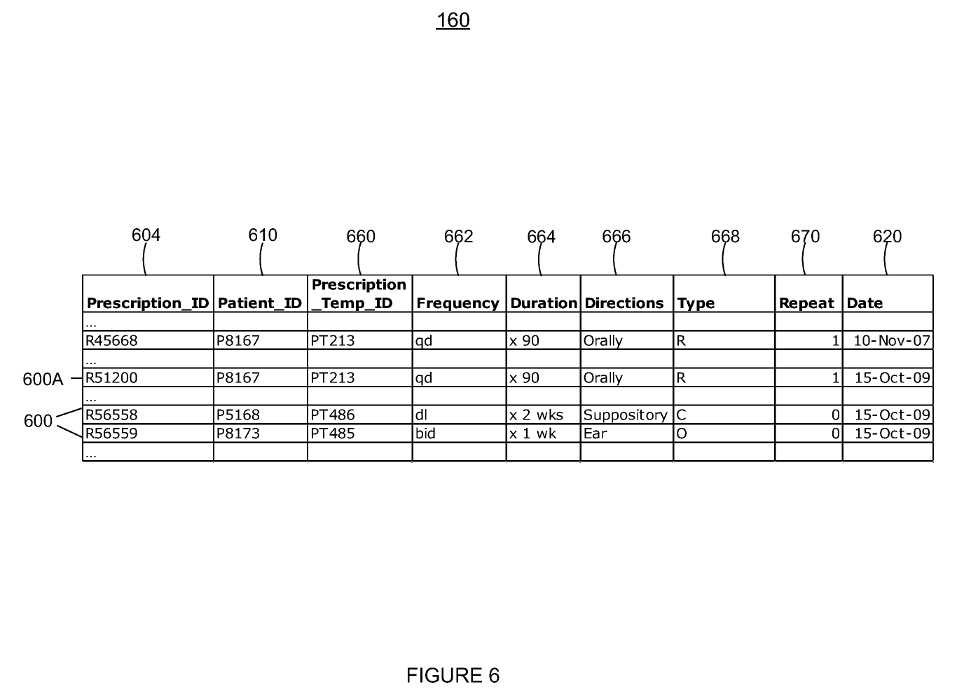

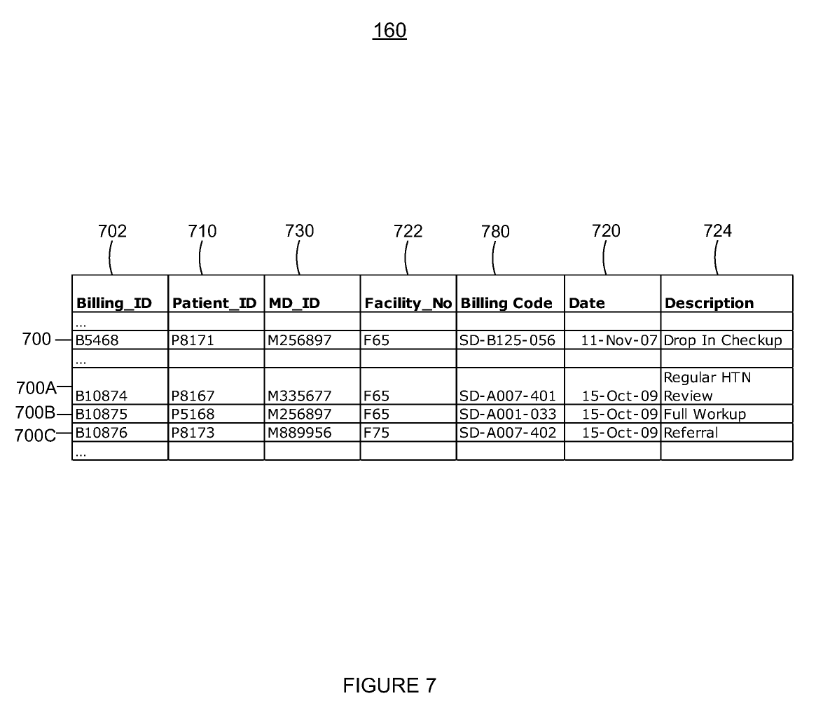

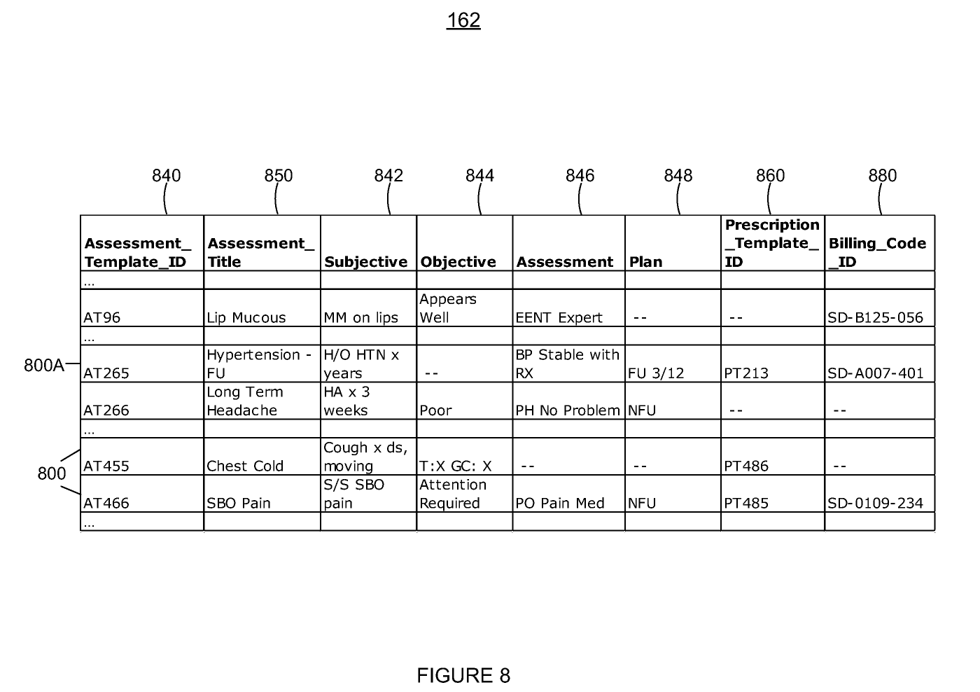

Referring now to FIG. 4 depicted therein is a schematic illustration of example assessment data records 400 containing exemplary data as may be stored in the patient database 160. Each time a patient is examined or assessed by a medical practitioner the details of that encounter may be entered into the patient database 160 using, for example, a doctor terminal 114, 114′ or a nurse terminal 116, 116′, and a corresponding new assessment record 400 may be created. An assessment record 400 may comprise an assessment identifier 408 that uniquely identifies the assessment record 400. An assessment record 400 may also correspond with a specific patient using, for example, a patient identifier 410 which may comprise a foreign key reference matching or otherwise corresponding to a patient identifier 310 of a patient information record 300. In order to facilitate the entry of patient assessment information, assessment data may be entered using a medical assessment template record 800 (see FIG. 8) as a starting point. An assessment template identifier or foreign key 440 identifying the assessment template record 800 used during data entry may be stored in the assessment records 400. The use of templates is described further below. An assessment may also correspond with one or more prescription records 600 (see FIG. 6) and a prescription record identifier or foreign key reference 404 linking the assessment records 400 to corresponding prescription record(s) 600 may be stored in the assessment records 400. Further, an assessment of a patient may be associated with a patient billing record 700 (see FIG. 7). A billing record identifier or foreign key 402 may be stored in the assessment records 400 thereby providing a link to corresponding patient billing record(s) 700. An assessment record 400 may also typically comprise the date 420 on which the assessment was performed. For the purposes of patient management the assessment records 400 may comprise a follow up field 422 which may denote if the patient requires a follow up appointment. Furthermore, the duration 424 of the assessment may be stored in the assessment record 400. In the example shown, the duration is stored in seconds and may be used for billing purposes or patient scheduling, for example. Additional or alternative data may be stored in the assessment data records 400.

An encounter or assessment of a patient's medical condition is typically assessed using the Subjective-Objective-Assessment-Plan or SOAP method. The assessment records 400 will therefore typically comprise fields for the subjective 442, objective 444, assessment 446 and plan 448 elements of the method. In the medical profession short forms are frequently used when recording SOAP information during a patient medical assessment. For example, referring to exemplary record 400B, the subject field 442 contains the data “H/O HTN×5 years. Doing well with Rx”. The short forms used in this example, along with their definitions, include: “H/O” or “HO” a short form for “history of”; “HTN” a short form for the medical condition “hypertension”; and, “Rx” a short form for “prescription”. Similarly, the objective field 444 of exemplary record 400B contains the data “BP 130/75R, well appearing”. In long hand this might be written out as “Blood Pressure: 130 (Systolic) 75 (Diastolic), Right Arm”. The assessment field 446 of exemplary record 400B contains the data “BP Rising with Rx”. Based on the previous discussion, “BP” stands for “blood pressure” and “Rx” stands for “prescription”. Finally, the plan field 448 of exemplary record 400B contains the data “FU 3/12″. The short hand “FU” or “F/U” is often used to denote “follow up” (e.g. a follow up appointment is necessary), and the numbers following may be fractions used to denote periods of time in months, weeks, or days wherein the denominator is used to denote the number of time periods in a year (e.g. the scale of the time period). Consequently, “FU 3/12” is shorthand for “follow up in three [from the numerator] months [from the denominator with 12 periods in a year]. In a similar manner, the short form “2/52” could be used to represent two weeks or “9/365” could be used to denote nine days, for example. Where other medical assessment methods or techniques are used additional or alternative data fields may be appropriately utilized. Other short forms used in FIG. 4 include: ‘MM’ which stands for “mucous membrane”; “EENT” which stands for “eyes, ears, nose and throat”; HA which stands for “head ache”; “PH” which stands for “past history”; “T” which stands for “temperature”; “GC” which stands for “general condition”; “S/S” which stands for “sings and symptoms”; “SBO” which stands for “small bowel obstruction”; “PO” which stands for “per oral”; and, “NFU” which stands for “no follow up”. Similarly, other shorthand or short forms may be used to conserve space and increase data entry speeds, for example. Those skilled in the art will appreciate that alternative or additional data fields may be included in an assessment record 400 and that other variants and modifications of the tables or databases storing the above noted assessment information are clearly possible

Referring to FIG. 6 depicted therein is a schematic illustration of example prescription data records 600 containing exemplary data as may be stored in the patient record database 160. When a patient 310, 610 is given a prescription the details of the prescription may be stored in the patient record database 160. Every time a new prescription is entered, at for example a nurse terminal 116, 116′, a new prescription data record 600 is created. A prescription record 600 may comprise a prescription identifier 604 that uniquely identifies the prescription record. A prescription data record 600 may also correspond with a specific patient using, for example, a patient identifier 610 which may match or otherwise correspond to a patient identifier 310 by, for example, comprising a foreign key reference. In order to facilitate the entry of prescription information the prescription data may be entered using a prescription template record 900 as a starting point. An identifier or foreign key 660 linking to the prescription template record 900 used during data entry may be stored in the prescription records 600.

A prescription record 600 will typically comprise the frequency 662, duration 664 and directions 666 for prescription use. For example, referring to exemplary prescription data record 600A it is shown that the frequency 662 is “qd” a short for the Latin expression “quaque die” meaning once per day. Similarly, the duration 664 is shown as “×90” a short form for “times 90” (e.g. for 90 days or for 90 doses). Finally, the directions 666 for use in the example are to take the medication “orally”. As will be appreciated, the directions field 666 may be used to store a wide range of information. Further, a prescription record 600 may have an associated type 668. Prescription record types may, for example, include: a recurring (R) prescription; a one-time (O) prescription; and, a control (C) prescription. Additionally, a prescription record 600 will typically comprise the date 620 the prescription was determined and the number of repeated prescription fulfillments or “refills” 670 that may be made by, for example, a drugstore or pharmacy.

The fields of a prescription data record 600 generally comprise information necessary to produce a complete and valid medical prescription for fulfillment by a pharmacy. For example, referring briefly to FIG. 15, an exemplary determined prescription as may be generated by the prescription generator 154 is shown generally as 1590. The date 1520, frequency 1562, duration 1564, directions for use 1566 and the number of repeats 1570 all correspond with fields 620, 662, 664, 666 and 670 of exemplary data record 600A, respectively.

In some embodiments a terminal 114, 114′, 116, 116′ may be used to select, highlight or point to a particular prescription record 600 or prescription template record 900 as may be displayed by system 100. In response system 100 may display additional information about the selected record such as, for example, the date when the selected drug was last prescribed. This information may be displayed in, for example, a pop up window. The pop up window may allow the drug in question to be reselected by a user in order to facilitate entry of a new prescription data record 600. If multiple drugs are associated with a prescription record the pop up window may allow multiple drugs to be selected.

An electronic patient record 170 may comprise: patient information records 300; assessment data records 400; and, prescription data records 600. Typically these will cross-reference or otherwise correspond to each other using the patient identifier 310 as the principle foreign key reference. Other embodiments of the electronic patient records 170 may contain more or less information. For example, patient billing records 700 or assessment history records 500 may be considered part of an electronic patient record.

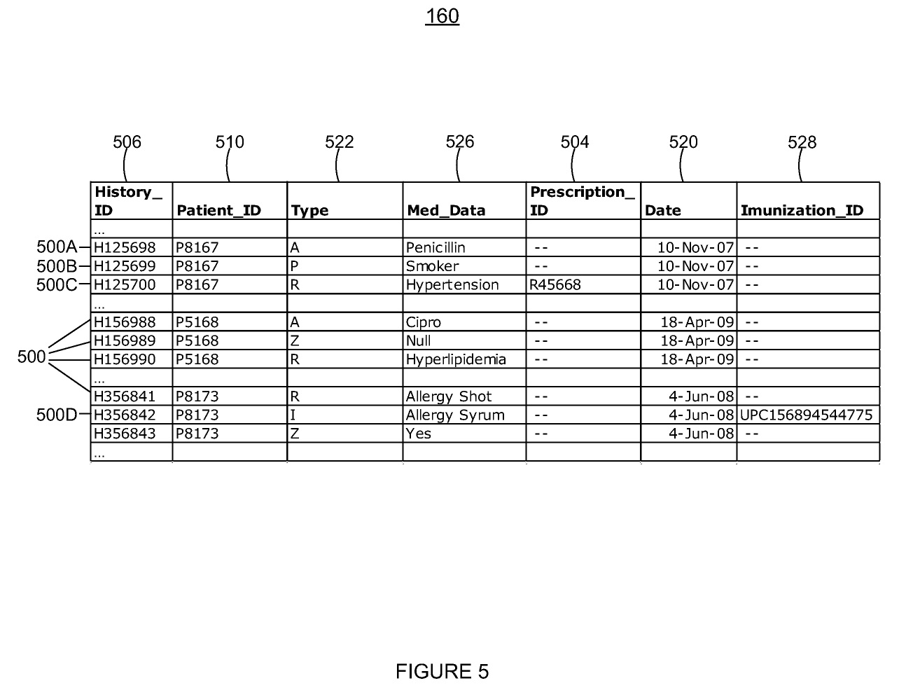

Referring to FIG. 5 depicted therein is a schematic illustration of example assessment history records 500 containing exemplary data as may be stored in the patient record database 160. In order to facilitate patient care it is valuable for medical practitioners to have an up to date picture summarizing a patient's outstanding medical conditions and indicators. The assessment history records 500 may be used to store any number of indicators for a patient. Using the date field 520 current or prior medical conditions may be filtered to produce an overview of a patient's medical status at a specific point in time, or for a given time period. An assessment history record 500 may comprise an assessment history identifier 506 that uniquely identifies the assessment history record. An assessment history record 500 may also correspond with a specific patient using, for example, a patient identifier 510 which may match or otherwise correspond to a patient identifier 310 by, for example, comprising a foreign key.

An assessment history record 500 may further comprise a type identifier 522 used to identify the type of medical condition or indicator being stored. Types of conditions or indicators may, for example, include: allergy (A) which may be used to denote any patient allergy to, for example, a drug; precaution (P) which may be used to denote a medically relevant caution or flag in the patient's medical history such as osteoporosis; recurring (R) which may denote a recurring medical condition such as hypertension; pending (Z) which may denote whether the patient has a pending appointment; and, immunization (I) which may denote whether the patient has received or still receives immunizations for a condition, disease or otherwise, for example. In association with a medical history record type 522 there may also be a corresponding medical data field 526 used to store the details of a medical history type. For example, exemplary medical assessment history record 500A illustrates that the allergy type (A) 522 corresponds with the medical data field 526 containing “penicillin”. This indicates that the patient has an allergy to penicillin. Similarly, exemplary medical assessment history record 500B illustrates that the patient has a precaution for smoking.

A medical assessment history record 500 may also be associated with a prescription data record 600 via a prescription identification field 504. A reference to a prescription may, for example, be stored in an assessment history record 500 when there is a recurring (R) drug prescription (e.g. exemplary medical assessment history record 500C). Similarly, the medical assessment history record 500 may be associated with an immunization container via an immunization identifier 528. This immunization identifier 528 may comprise a UPC code from the immunization container. An immunization identifier 528 may, for example, be stored in an assessment history record 500 having an immunization (I) type 522 (e.g. exemplary assessment history record 500D). Those skilled in the art will appreciate that alternative or additional condition types or indicators may be used or that alternative ways of storing patient medical history may be devised and implemented.

In another embodiment the immunization identifier 528 or a medical assessment history record 500 with an immunization (I) type 522 may comprise a foreign key reference to an immunization history record (not shown). For example, immunization history records may be stored in a manner that is substantially similar to the assessment history records 500 discussed above. In this manner system 100 may be used to store a patients immunization history.

In another embodiment a medical assessment history record 500 with a pending (Z) type 522 may comprise a foreign key reference to a pending appointment record (not shown). For example, pending appointment records may be stored in a manner that is substantially similar to the assessment history records 500 discussed above. In this manner system 100 may be used to store one or more pending or follow-up appointments. Pending appointment records may be viewed on any doctor or nurse terminal 114, 114′, 116, 116′ or may be linked with a calendaring system to provide for warnings or the integrated scheduling of appointments.

Referring now to FIG. 7 depicted therein is a schematic illustration of example billing data records 700 containing exemplary data as may be stored in the patient record database 160. In order to facilitate the process of billing insurance providers, governmental institutions, or individuals for medical services rendered, each medical assessment record 400 may be associated with at least one billing data record 700. A billing data record 700 may comprise a billing record identifier 702 that uniquely identifies the billing data record. A billing data record 700 may also correspond with a specific patient using, for example, a patient identifier 710 which may correspond to a patient identifier 310 by, for example, comprising a foreign key.

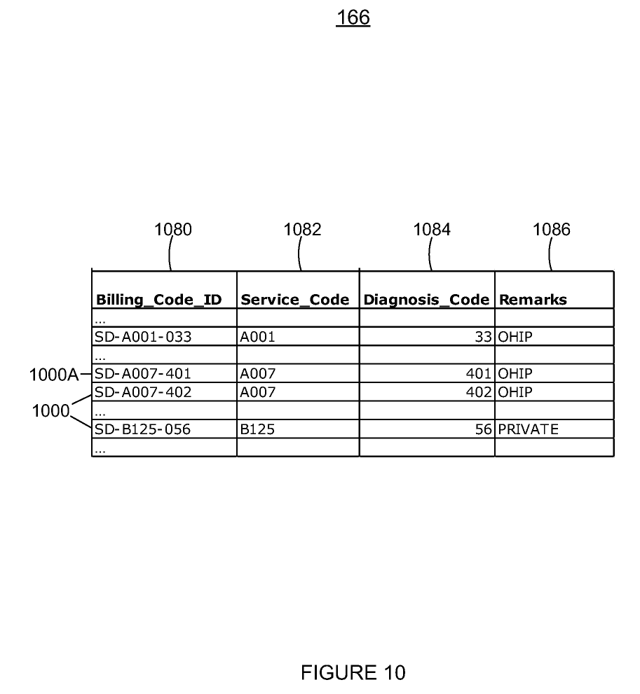

Each billing data record 700 may be associated with a medical doctor identifier 730 which may be used to identify the medical professional that actually performed the work being billed. It should be noted that the medical doctor identifier 730 in the billing data records 700 may, in some instances, not correspond with the medical doctor identifier 330 in the patient information records 300. For example, a patient's primary doctor may not have performed the service being billed. The billing data records 700 may also comprise the following: a facility number 722 used to identify the facility or location where a medical service was performed; a date 720 used to specify the date on which the service was performed; and, a description 724 of the service performed. Finally, the billing data records 700 may correspond with at least one specific billing code record (see FIG. 10) using, for example, a billing code identifier 780, which may match or otherwise correspond to a billing code record by, for example, comprising a foreign key reference. As billing and financial transactions are often complicated and highly regulated, it will be appreciated that many different configurations and variations of the above noted billing data may be necessary.

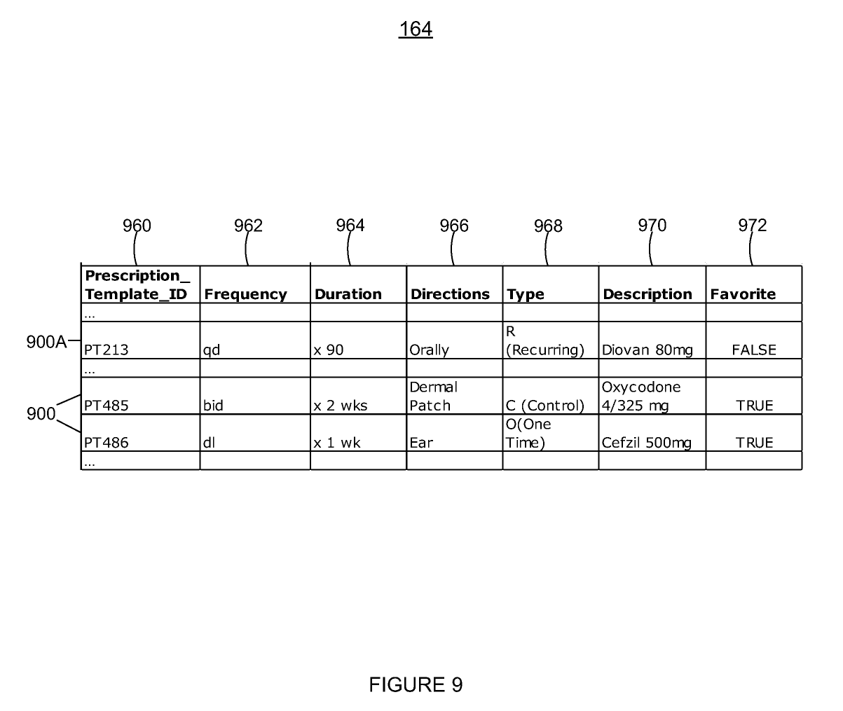

Referring now to FIG. 8 depicted therein is a schematic illustration of example medical assessment template records 800 containing exemplary data as may be stored in the assessment template database 162. These records 800 form a set containing information describing various medical conditions, as such they may be alternatively referred to as medical condition templates. A medical assessment template record 800 may comprise an assessment template identifier 840 that uniquely identifies the assessment template record 800 and which may be used as a primary key or candidate key to link the record 800 to, for example, a patient assessment record 400. An assessment template may also correspond with a specific default prescription template record (see FIG. 9) using, for example, a prescription template identifier 860 which may be used as a foreign key reference field that uniquely identifies the corresponding prescription template record (described below). Similarly, an assessment template record 800 may also correspond with a specific default billing code record (see FIG. 10) using, for example, a billing code identifier 880 which uniquely references a specific billing code record (described below) by comprising, for example, a foreign key. An assessment template may therefore correspond with default prescription information and/or default billing information that may be modified and stored in, for example, a prescription data record 600 and/or a billing data record 700. An assessment template record 800 may also comprise the following: an assessment template title 850; a subjective field 842; an objective field 844; an assessment field 846; and, a plan field 848. Fields 842, 844, 846 and 848 correspond to fields 442, 444, 446 and 448 respectively as discussed above in relation to assessment data records 400. It will be appreciated by those skilled in the art that additional correspondences between patient assessment template records 800 and other database tables described herein may be accomplished by, for example, referencing the unique identifier 840 using a foreign key constraint.

An assessment template record 800 is pre-populated with typical medical assessment data, and as such may be used to facilitate the input of, for example, patient assessment data records 400. A medical assessment template record 800 may, for example, be used by the patient record module 140 and input module 142 to generate a default pre-populated patient assessment template (e.g. a data entry form) for a known medical condition. The use of templates is described further below.

Referring now to FIG. 9 depicted therein is a schematic illustration of example prescription template records 900 containing exemplary data as may be stored in the prescription template database 164. These 900 records form a set containing information describing different determined prescriptions. A prescription template record 900 may comprise a prescription template identifier 960 that uniquely identifies the prescription template record 900 and which may be used as a primary key or candidate key to link the record 900 to, for example, an assessment template record 800. A prescription template record 900 may also typically comprise the following: a frequency 962 for administration of the prescription; a duration 964 for the administration of the prescription; directions 966 for administration of the prescription; a description 970 of the prescription, which may typically take the form of a drug name and dosage; and, a favorite field 972 which may be used to mark the prescription for efficient access by a medical practitioner using, for example, a favorites list (as discussed below). Further, a prescription template may be associated with a prescription type 968. The possible types 968 are the same as those discussed above with respect to the prescription type field 668 of the prescription data records 600. Similarly, for a more detailed description of fields 962, 964 and 966 please refer to the discussion above regarding corresponding fields 662, 664 and 666 of the prescription data records 600. It will be appreciated by those skilled in the art that additional correspondences between prescription template records 900 and other database tables described herein may be accomplished by, for example, referencing the unique identifier 960 using a foreign key constraint.

A prescription template record 900 is pre-populated with typical prescription data, and as such may be used to facilitate the input of, for example, patient prescription data records 600. A prescription template record 900 may, for example, be used by the patient record module 140 and input module 142 to generate a default pre-populated prescription template (e.g. a data entry form) for a commonly prescribed drug, device or pharmaceutical preparation, for example. The use of templates is described further below.

Referring now to FIG. 10 depicted therein is a schematic illustration of example billing code records 1000 containing exemplary data as may be stored in the billing code database 166. A billing code record 1000 may comprise a billing code identifier 1080 that uniquely identifies the billing code record 1000. Billing code records 1000 may comprise a wide variety of information. For example, in Canada the Ontario Health Assistance Program (OHIP) uses a two-tiered billing code system including service codes and diagnosis codes. Each service code may have one or more diagnosis codes. Therefore, in an embodiment designed to accommodate billing through OHIP, a billing code record 1000 may comprise the following: a service code 1082 that specifies the nature of or type of service that was rendered by the medical professional; a diagnosis code 1084 that further specifies the nature of the patient's medical condition; and, a remarks field 1086 that may be used to identify the destination or billing system being used. As previously discussed, a billing data record 700 may correspond with a specific billing code 1000 using, for example, a billing code identification field 780 which may match or otherwise correspond to a billing code identifier 1080 by, for example, comprising a foreign key. It will also be understood by persons skilled in the art that additional correspondences between billing codes 1000 and other database tables described herein may be accomplished by, for example, referencing the unique identifier 1080 using a foreign key constraint.

In order to utilize templates to facilitate data entry (e.g. as discussed further below) a user of system 100 will require the ability to search and manage the templates stored in, for example, the assessment database 162, the prescription database 164 and the billing database 166. The selection and the management of relationships between data records and template records may be performed by, for example, the management module 146 and the search module 148. A variety of methods may be used to facilitate the user selection of templates. For example, in one embodiment the search module 148 may be configured to query the assessment database 162 to obtain a list of all the available assessment template records 800. The search module 148 may then be configured to, for example, sort the template records 800 alphabetically based on their assessment title 850. The search module 148 may then display the alphabetical list of assessment template records 800 by title 850 on a doctor or nurse terminal 114, 114′, 116, 116′. Furthermore, the search module 148 may also display a search tool including, for example, an input box in association with the alphabetical list of templates. Using a doctor or nurse terminal 114, 114′, 116, 116′, for example, a user may be able to scroll through the alphabetical list of template record titles to find a desired template. Alternatively, the user may be able to enter a search string into the search tool input box and in response the search module 148, for example, may be configured to filter out or exclude all templates whose title 850 does not match the search string that was entered by the user. For example, the search string may comprise a diagnosis (e.g. “Ton” for Tonsillitis) or a chief symptom (e.g. Sore Throat). Once the user has located the desired template they may select the template for use by, for example, clicking on the title of the desired template using a mouse that is operatively connected to the doctor or nurse terminal 114, 114′, 116, 116′ they are using. In response to the selection of a template the search module 148 may be configured to send the selected assessment template record 800 to the input module 142 which may be configured to generate and display an initial assessment summary (as discussed below) based on the selected assessment template record 800 on the doctor or nurse terminal 114, 114′, 116, 116′.

In some embodiments search module 148 may display a set of default assessment template records 800 in response to the retrieval of a specific patient's electronic medical records. For example, the Assessment_Title 850 of the last three assessment templates 800 used for a specific patient may be displayed in association with a patient's name. If one of the displayed Assessment_Titles 850 is selected search module 148 may be further operable to display the full contents of the assessment template 800. In this manner a medical practitioner can readily select assessment templates 800 based on patient's previous assessment history.

In another embodiment, an assessment template record 800 may include a data field comprising, for example, a counter that tracks the total number of times that the template record 800 has been used. The counter may be incremented by, for example, the search module 148 each time a template record 800 is selected by a user as discussed above. As previously described, the search module 148 may be configured to obtain a list of all the available assessment template records 800 and generate and display an alphabetical list based on the templates title 850. Using the counter field the search module 148 may be configured to sort the list of assessment template records 800 based on the number of times the templates have been used. For example, the search module 148 may use the counter data field to sort the templates in descending order from the most used assessment template record 800 to the least used. The search module 148 may then be configured to display the list of assessment template records (i.e. by assessment template title 850) in descending order of use. In association with the assessment template title 850, the search module 148 may also be configured to display the number of times each assessment template record 800 has been used or it may be configured to, for example, color code or highlight assessment template titles 850 corresponding with assessment template records 800 that have been used more than a certain number of times. Similarly, in another instance, an assessment template record 800 may include a last used date field which tracks the last time the template was selected by a user. The date field may be updated with the current date by, for example, the search module 148 each time a template record 800 is selected by a user as discussed above. The search module 148 may, for example, be further configured to sort and display the list of assessment templates based on the last used date.

In another aspect a prescription template 900 may comprise a favorite field 972. This favorite field 972 may be, for example, a Boolean data field that is initially set to ‘FALSE’. In one embodiment the management module 146 may be configured to generate and display an alphabetical list of prescription templates 900 based on, for example, their description 970 in a manner substantially similar to that discussed above with respect to the search module 148 and assessment templates 800. The management module 146 may also be further configured to display, for example, a check box beside each prescription template description 970 when it displays the alphabetical list of prescription templates 900. Using a terminal 114, 114′, 116, 116′ users may select their favorite prescription templates by, for example, clicking on the check box listed next to the prescription template description 970 in the list displayed by management module 146. In response to users clicking said check box(s) the management module 146 may be configured to update the favorite field 972 of the corresponding prescription template record 900 in the prescription database 164 to ‘TRUE’. Prescription templates with a favorite field 972 set to ‘TRUE’ may be alternatively referred to as prescription favorites 902. Those skilled in the art will appreciate that numerous other methods for displaying, selecting and managing a list of prescription favorites 902 and/or assessment favorites 802, for example, are possible.

The search module 148 may be configured to use the favorite field 972 and/or prescription favorites 902 to facilitate various additional methods for displaying prescription templates 900 for searching and selection. For example, instead of listing prescription templates 900 alphabetically by prescription description 970, as discussed above, the search module 148 may, by default, be configured to query the prescription database 164 for a list of only the prescription favorites 902. The search module may then be further configured, for example, to display a list of prescription favorites using the description 970 in the order they were last used if, for example, the prescription favorites 902 also included a last used date field. The search module 148 may also display, for example, a button entitled ‘View All’ in association with a list of prescription favorites 902. In response to the ‘View All’ button being selected by a user via a terminal 114, 114′, 116, 116′ the search module 148 may be configured to display a full alphabetical list of prescription templates 900. Alternatively, the search module 148 may be configured to display a list of all of prescription templates 900 such that the prescription favorites 902 are distinguished from the prescription templates 900 with a favorite field 972 equal to “FALSE”. For example, the search module 148 may be configured to highlight the prescription favorites 902 or present them in a different part of the display on a terminal 114, 114′, 116, 116′. Search module 148 may also be further configured to search for prescription templates 900 using categories. For example, a category such as Dermatology may be selected and in response the search module 148 may display only prescription templates 900 which correspond with medications used in the field of Dermatology. Those skilled in the art will appreciate that the exemplary search interfaces described above, and their supporting data structures, are by no means exhaustive and that numerous variations and combinations of the techniques discussed above are possible in variant implementations and embodiments. Furthermore, although specific examples for the assessment template records 800 and prescription template records 900 have been presented it will be understood that these techniques may be applied in any instance where the user may be required to select data of any type.

The management module 146, for example, may be configured to facilitate the input and storage of new or modified assessment template records 800, prescription template records 900 and billing code records 1000 after they have been created or modified by a user. For example, a medical practitioner may create or modify assessment template records 800, prescription template records 900 and billing code records 1000 to reflect their own medical practice and/or personal preferences. The process of using and modifying template records will be described further below.

The management module 146 may also be configured to manage the associations between data and template records. For example, the management module may be operable to permit a user (e.g. using a doctor or nurse terminal 114, 114′, 116, 116′) to associate and/or update the correspondence between an assessment template record 800 and a default prescription template record 900 via the prescription template identifier 860. Similarly, the management module 146 may be configured to permit the management of associations between assessment template records 800 and billing code records 1000 via the billing code identifier 880, for example. Those skilled in the art will appreciate that the operability of the management module 146 is not limited to the specific examples recited above and that other associations and correspondences between data records and template records may be managed by the management module 146.

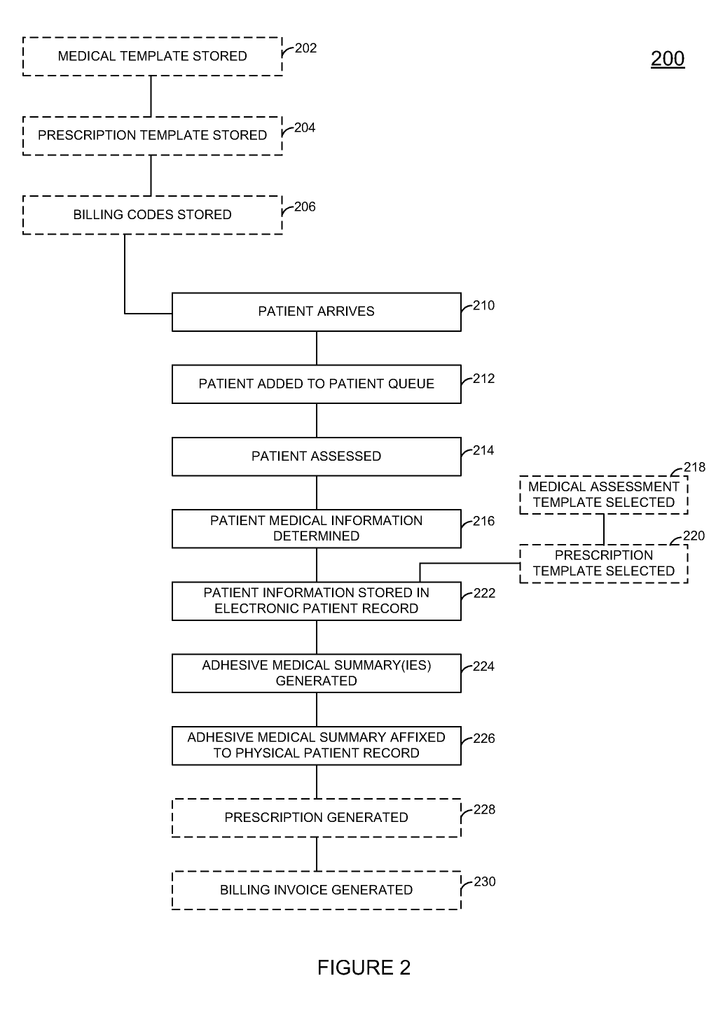

Reference will now be made to FIG. 2 and FIGS. 11 through 18 in order to facilitate the description of a method for managing patient medical information as may be performed by the system of FIG. 1. Referring first to FIG. 2, a flowchart illustrating the steps of a method for managing patient medical information, in accordance with at least one embodiment, is shown generally as 200. Some steps of the method which may optionally be performed and/or performed at different times are denoted using dashed blocks. At Block 202 medical assessment templates 800 may be stored in the system 100, for example in memory 130. This may involve modifying existing medical assessment template records 800 or creating new templates. Similarly, at Block 204 prescription templates 900 may be stored in the system 100. This may involve modifying existing prescription template records 900 or creating new ones. The modification or creation of templates may be performed via doctor terminals 114, 114′ or nurse terminals 116, 116′ that access the management module 146, for example. In some embodiments an application interface similar to the one illustrated in the screen shot of FIG. 13, for example, may be used to create, modify, save and remove templates from the system 100. The interface illustrated in FIG. 13 may, for example, be generated by the management module 146 and accessed by users via terminals 114, 114′, 116 and 116′. The process of using and editing template records will be described further below.

At Block 206 billing codes 1000 may be stored in the system 100. This may involve modifying existing billing codes 1000 or creating new ones. Although not shown, those skilled in the art will appreciate that a billing code management interface (e.g. part of management module 146) may be provided to permit users to create, modify, save and remove billing codes from the system 100.

At Block 210 a patient may arrive at a medical practitioner's office. For example, the patient may be a person, or in the case of a veterinary practice it may be an animal. In some embodiments the patient may be asked by a staff member to produce identification and/or verification of insurance. For example, in Canada human patients generally show medical staff a government issued health card. In at least one embodiment a card (e.g. magnetic or RFID) may be swiped or passed near a card reader in order to identify the patient. The card reader may be operatively connected to, for example, a nurse terminal 116′ 116′ and configured to communicate with the patient record module 140 (e.g. using a direct, wired or wireless interface, for example). A patient information record 300 may be retrieved by input module 142 in response to, for example, the swiping of a patient's health card at a card reader. For example, on Oct. 15, 2009 the patient John Doe may arrive at Dr. Smith's general family medical practice, for one of his regularly scheduled Hypertension follow up appointments, and present his health card to a nurse at the front desk. The nurse may then, for example, swipe the health card using a card reader in order to obtain John Doe's insurance identifier 322 “I5624128”. This insurance identifier, or another form of identification, may be used to retrieve John Doe's patient information record 300A from the patient database 160. John Doe's patient information may then be displayed, for example, on the nurses terminal 116, 116′ by patient record module 140.

At Block 212 the patient may be added to a queue of waiting patients. The queue of waiting patients may be managed manually and/or electronically. In a manual system the patient's physical chart 1100 may be retrieved from patient record storage 180 and placed in some form of physical queue for retrieval by a staff member or a medical practitioner in an orderly fashion (e.g. on a first-come-first-serve basis). In an electronic system the queue may be managed by, for example, the scheduling module 158. For example, referring briefly to FIG. 12 an example screen shot as may be produced by the patent record module 140 and used to implement steps of the method described herein is shown generally as 1200. In the illustrated screen shot 1200 an electronic queue with two waiting patients 1228 is shown. Patients may be added to an electronic queue by, for example, the scheduling module 158 in response to the identification obtained in Block 210. For example, after retrieving a patient information record 300 in Block 210 the input module 142 may be configured to send the patient identifier 310 and/or other corresponding patient information to the scheduling module 158. In response, the scheduling module 158 may be configured to add the patient's identifier 310 and/or other identifying information such as the patient's name 324 to, for example, a First-In-First-Out (FIFO) stack, which may be stored in memory 130. The scheduling module 158 may be configured to display the contents of the FIFO stack in, for example, a drop down list as illustrated by the waiting patient queue 1228. When a new patient is to be called for their appointment a staff member or medical practitioner may, using a terminal 114, 114′, 116, 116′, select the waiting queue drop down box 1228 in order to view a list of waiting patients and select the next patient to be assessed. When a patient is selected from the waiting queue 1228 by a user the patient record module 140, for example, may be configured to retrieve the patient's electronic patient record from the patient database 160 and display it on a doctor terminal 114, 114′. Furthermore, the scheduling module 158 may be configured to remove the selected patient from the electronic queue. After being selected form the electronic queue the patient may be called for their appointment by, for example, a staff member or medical practitioner. As will be appreciated by those skilled in the art, the scheduling module 158 may manage the electronic queue of patients in numerous ways depending upon, for example, the preferences of the medical practitioner. For example, instead of using a FIFO queue the scheduling module 158 may be configured to queue patients based on the severity of their condition or the estimated length of their appointment as may, for example, be input by a medical practitioner using a terminal 114, 114′, 116, 116′ when the patient arrives at Block 210. Furthermore, it will also be understood that, for example, the drop down list 1228 may be used to select patients in an order that is different from the order they are presented by the scheduling module 158. In such cases, the scheduling module 158 may be configured to manage the list of patients accordingly by removing the selected patient and resorting the queue, for example.

At Block 214 the patient may be assessed by one or more medical practitioner(s) to determine the patient's medical condition. The assessment may take many forms including an examination and/or testing, for example. Examination may, for example, involve questioning of the patient, physical examination of the patient or the drawing of bodily fluids for testing. Such an assessment may take place, for example, in a private examination room. For example, as part of a regular Hypertension examination Dr. Smith may take John Doe's blood pressure and pulse and assess him for obesity factors.

At Block 216 the patient medical information corresponding to a patient's medical condition is determined. This may include the determination of one or more prescriptions. In assessing the patient's condition at Block 214 the medical practitioner may reach certain conclusions and obtain certain diagnostic information that should then be recorded. This medical information may be used in the future, or may simply serve as a record of the assessment. The information may be useful for billing, insurance, prescription, referral, follow-up or legal purposes, for example. In at least some embodiments the information that is determined may include: subjective information related by the patient; objective information determined by the medical practitioner; assessment notes made by the medical practitioner; and, a plan for treatment developed by the medical practitioner. Those skilled in the art will appreciate that alternative or additional patient information may be determined and recorded by a medical practitioner.

At Block 222 using the patient record module 140 the medical practitioner or a staff member stores the medical condition information determined in Block 216 in, for example, the patient database 160 (e.g. using assessment records 400, prescription records 600 and billing records 700). This may be achieved by inputting the medical condition information into memory 130 using, for example, a doctor terminal 114, 114′ displaying the patient's medical records as illustrated by FIG. 12. As described above, each assessment of a patient may be entered as a new assessment record 400, and each determined prescription may be entered as a new prescription data record 600. In addition, billing information corresponding with the assessment may also be generated and/or input as, for example, a new billing data record 700.

For example, Dr. Smith having assessed John Doe's medical condition at Block 214 may input, using a doctor terminal 114, 114′ and input module 142, the determined assessment information from Block 216 as exemplary assessment data record 400A. With reference to the discussion above regarding the short forms used during the recording of SOAP information, exemplary assessment record 400A illustrates Dr. Smith's determination that John Doe has a five year history of hypertension but is doing well on a prescription (see subject field 442). Further, his blood pressure is 130 over 75 and he is showing some signs of target organ damage (see object field 444), and his blood pressure is stable with his prescription (see assess field 446). Further, it is shown that Dr. Smith has scheduled John Doe for a follow up appointment in 3 months (see plan field 448). Finally, exemplary record 400A indicates that Dr. Smith issued a prescription (prescription identifier 404 “R51200”) and entered billing data (identifier 402 “B10874”) as discussed further below.

As noted in the description of the exemplary assessment record 400A discussed above, Dr. Smith has determined and input a prescription for John Doe using, for example, the input module 142 and a doctor terminal 114, 114′. The determined prescription information input by Dr. Smith is illustrated in exemplary data record 600A, which has a prescription identifier 604 “R51200” corresponding with the prescription identifier 404 of exemplary assessment record 400A. Furthermore, Dr. Smith has entered billing information for the assessment corresponding to exemplary billing record 700A. As illustrated, billing record 700A has a billing identifier 702 “B10874” that corresponds with the billing identifier 402 of exemplary assessment record 400A. Finally, it may be noted that exemplary records 400A, 600A and 700A all have the patient identifier 410, 610, 710 “P8167” which corresponds to John Doe's patient identifier 310 in patient information record 300A.

Referring to FIG. 12 there is illustrated a screen shot 1200 of an interface, as may be generated by the patient record module 140, that may be used for inputting and viewing patient information. The interface illustrated by screen shot 1200 may be used to facilitate, for example, the entry of assessment, prescription and billing data in accordance with the method described herein. Continuing with the John Doe example, at the top of interface 1200 data fields reflecting the contents of the exemplary patient information record 300A are shown. Specifically, the name 1224, patient number 1210 and age 1236 correspond with fields 324, 310 and 336 of exemplary patient information record 300A respectively. The dates 1220 and 1220′ may also be extracted from the assessment data records 400.

On the left hand side of the screen under the heading “Medical History” there is illustrated information corresponding with the exemplary assessment history records 500A, 500B and 500C. For example, the type indicator 1222 “A” and the data field 1226 containing “penicillin” correspond respectively with fields 522 and 526 of exemplary assessment history record 500A. This indicates that the patient, John Doe, has an allergy to Penicillin. Any reasonable number of medical assessment history records 500 for any time period may be shown in this area. In the illustrated screen shot 1200, only the history records for John Doe from Nov. 10, 2007 are shown. As discussed, the input module 142 and a terminal 114, 114′, 116, 116′, for example, may be used by a medical practitioner to enter assessment information in assessment records 400, prescription records 600 and billing records 700. The input module 142 may also be configured to retrieve assessment history records 500 from the patient database 160 and display them on a terminal 114, 114′, 116, 116′. The input module may be further configured to allow a user to modify, edit and save the assessment history records 500 displayed by the input module 142. In the alternative, the patient record module 140 may be configured to automatically generate patient history information based on information from, for example, the assessment 400, prescription 600 and billing 700 records. Those skilled in the art will appreciate that there may be many ways in which the patient record module 140 may query the patient database 160 and generate patient history information using, for example, the assessment 400, prescription 600 and billing 700 records.

On the right hand side of the screen under the heading “Medication” there is shown information corresponding with the exemplary prescription data record 600A. For example, the type 1268, duration 1264 and recurring 1270 fields shown correspond with fields 668, 664 and 670 respectively in exemplary prescription record 600A. Similarly the medication desription 1270′ corresponds with the description 970 of prescription template 900A.

At the bottom of the screen under the heading “Billing” there is illustrated information corresponding with the exemplary billing data record 700A. Specifically, the billing code 1280, the date 1220″ and the description 1224′ all correspond with fields 780, 720 and 724 respectively of billing data record 700A. The service code 1282, the diagnosis code 1284 and the billing type 1286 correspond with exemplary billing code record 1000A as connected to the billing data record 700A using billing code field 780.

Those skilled in the art will appreciate that the data fields displayed by, for example, the patient record module 140 as illustrated by screen shot 1200 may include, for example, editable input fields, pre-populated drop down boxes, pick lists, or other graphical user interface elements which may be used to facilitate data entry. Consequently, it will be understood that the patient record module 140 may be configured to display an interface as exemplified by screen shot 1200, for example, that permits a medical practitioner to view, input and/or modify a patient's medical assessment history data 500 (left pane), determined prescription information 600 (right pane), and billing information 700 (bottom pane). For example, patient record module 140 may be configured to query patient database 160 for patient assessment history records 500. The patient record module 140 may then be configured to display the patient assessment history records history 500 on a terminal 114, 114′, 116, 116′ using editable graphical user interface elements as shown, for example, in the left pane of exemplary screen shot 1200. A user may then view and edit the data fields displayed by input module 142 by interacting with the editable graphical user interface elements. The patient record module 140 may be further configured to save the changes made by a user by modifying the assessment history records 500 stored in patient database 160. Similarly, though not shown in screen shot 1200, patient record module 140 may be configured to display and facilitate the input of patient assessment information as stored in patient assessment records 400.

Returning to FIG. 2, to facilitate the entry of the electronic patient record data at Block 222 the step of selecting a medical assessment template 800 from a medical assessment template set may be performed at Block 218. Based on the condition of a patient as assessed at Block 214 a medical practitioner may use the search module 148 and a terminal 114, 114′, 116, 116′ to select the appropriate assessment template 800 to use as the starting point for entering a specific patient's medical condition (see description of template selection above). For example, after assessing John Doe at Block 214 Dr. Smith may determine that the best way to input the assessment information (e.g. as determined at Block 216) at Block 222 is to use a template for a hypertension follow up appointment. Using a doctor terminal 114, 114′ Dr. Smith may search for a hypertension template using, for example, search module 148. As previously described, Dr. Smith may use the search module 148 to, for example, scroll through a list of assessment template titles 850 in order to find one entitled, for example, “Hypertension-FU”, as exemplified by assessment template record 800A. Once the “Hypertension-FU” template 800A has been located by Dr. Smith he may select the template 800A. In response to selection of a template 800 the management module 146, for example, may be configured to display an assessment summary as described further below which may be pre-populated with data including data derived from the selected assessment template 800. Alternatively, the medical practitioner may manually enter the medical assessment information (e.g. using the patient record module 140 which may display the interface 1200 as described above).

Referring to FIG. 13 there is illustrated an example screen shot 1300 of an interface displaying an initial assessment summary 1390, as may be generated by management module 146. This interface 1300 may be used by a medical practitioner to facilitate the input or modification of, for example, medical assessment records 400. In response to the selection of an assessment template 800 by a user at Block 218 management module 146 may be configured to generate and display an initial assessment summary 1390. This initial assessment summary 1390 may include data from the selected assessment template 800 and the management module 146 may display this data using, for example, editable graphical user interface elements such as editable text fields. For example, the editable text fields S: 1342, O: 1344, A: 1346 and P: 1348 of the illustrated initial assessment summary 1390 correspond with the subjective 842, objective 844, assessment 846 and plan 848 fields of exemplary assessment template record 800A which Dr. Smith selected at Block 218 as discussed above. Using a terminal 114, 114′, 116 or 116′ a user may edit and modify the initial assessment summary 1390 that is displayed by management module 146. For example, Dr. Smith may use a doctor terminal 114, 114′ to edit the data fields of the initial assessment summary 1390 displayed by management module 146 in the exemplary interface 1300.

Referring to FIG. 17, there is illustrated another example screen shot 1700 of an interface displaying a completed assessment summary 1790 as may be generated by management module 146. Comparing FIG. 17 with FIG. 13 it will be clear that the completed assessment summary 1790 has many elements in common with the initial assessment summary 1390 (e.g. the A: 1346, 1746 and P: 1348; 1748 fields are identical). This correspondence of data is expected where an initial assessment summary 1390, which may include data derived from an assessment template 800, is used as the starting point for entering the specifics of a patient assessment as shown by completed assessment summary 1790. For example, using the initial assessment summary 1390 as a starting point Dr. Smith may use a doctor terminal 114′ 114′ to input specific details regarding John Doe's hypertension condition such as the fact that he now objectively displays evidence of target organ damage (e.g. data field 1744). Similarly, Dr. Smith may enter new data fields such as 1760 which reads “Rx: as labeled”, and 1724 which reads “JD” (e.g. a short form for John Doe the current patient). Those skilled in the art will appreciate that various other methods for displaying and editing data in, for example, an initial assessment summary 1390 are possible and the examples described are for illustrative purposes only.

After modification, data from the completed medical assessment summary 1790 may be saved in, for example, a patient assessment record 400 by, for example, the management module 146. Referring to FIG. 17 and FIG. 4, it is shown that the S: 1742, O: 1744, A: 1746 and P: 1748 fields in a completed patient assessment summary 1790 may correspond with the subject 442, object 444, assess 446 and plan 448 fields respectively in, for example, an exemplary assessment data record 400A. In alternate embodiments, data from the completed patient assessment summary 1790 may also be saved to, for example, the following: a patient information record 300; a patient assessment history record 500; a prescription data record 600; and/or a billing data record 700. Finally, it may be noted that the exemplary assessment data record 400A comprises the assessment template identifier 440 “AT265”. This corresponds with the assessment template identifier 840 of exemplary assessment template record 800A. This correspondence is included in order to visually confirm that the assessment data record 400A was entered using the assessment template 800A.

The management module 146 may also be configured to create new medical assessment template records 800 using, for example, data entered by a user in an assessment summary 1390, 1790. For example, a user may start with a blank assessment summary (not shown) or an initial medical assessment summary 1390 based on an existing medical assessment template record 800. The blank or initial assessment summary 1390 may be generated, displayed and modified in a manner similar to that which is described above. However, instead of saving the data in the completed assessment summary 1790 to, for example, a patient assessment record 400 as described above, the management module 146 may be configured to save the data in a new medical assessment template record 800. In this manner new medical condition templates 800 can be added to system 100 for future use.

As part of the determination of patient medical information at Block 216 one or more prescriptions may be determined. Therefore, at Block 220 the medical practitioner may optionally select a prescription template 900 to facilitate the input of determined prescription information records 900. The prescription template 900 may be selected from a list of prescription templates 900 using, for example, a method similar to the one discussed above with respect to assessment templates 800. For example, if a medical practitioner determines that the patient requires a prescription as part of the medical information determination at Block 216 then the medical practitioner may, for example, use the search module 148 and a terminal 114, 114′, 116, 116′ to select a corresponding prescription template 900 to use as the starting point for entering the details of a specific patient's prescription data record 600. Alternatively, the medical practitioner may manually enter the prescription information (e.g. using the patient record module 140 which may display the interface 1200 as described above).

For example, after assessing John Doe at Block 214 Dr. Smith may determine at Block 216 that John Doe requires a prescription for “Diovan” to control his Hypertension condition. Dr. Smith may also determine that best way to input the prescription information in Block 222 is to use a template for “Diovan” to facilitate data entry. Using a doctor terminal 114, 114′ Dr. Smith may search for a “Diovan” template using, for example, search module 148. As previously described, Dr. Smith may use the search module 148 to, for example, scroll through a list of prescription descriptions 970 in order to find one with the description “Diovan 80 mg” as exemplified by prescription template record 900A. Once the “Diovan 80 mg” template 900A has been located by Dr. Smith he may select the template. In response to selection of a template 900 the management module 146 may be configured to display an initial prescription summary as described further below which may be pre-populated with data including data derived from the selected prescription template 900. Alternatively, the medical practitioner may manually enter the determined prescription information (e.g. using the patient record module 140 which may display the interface 1200 as described above).

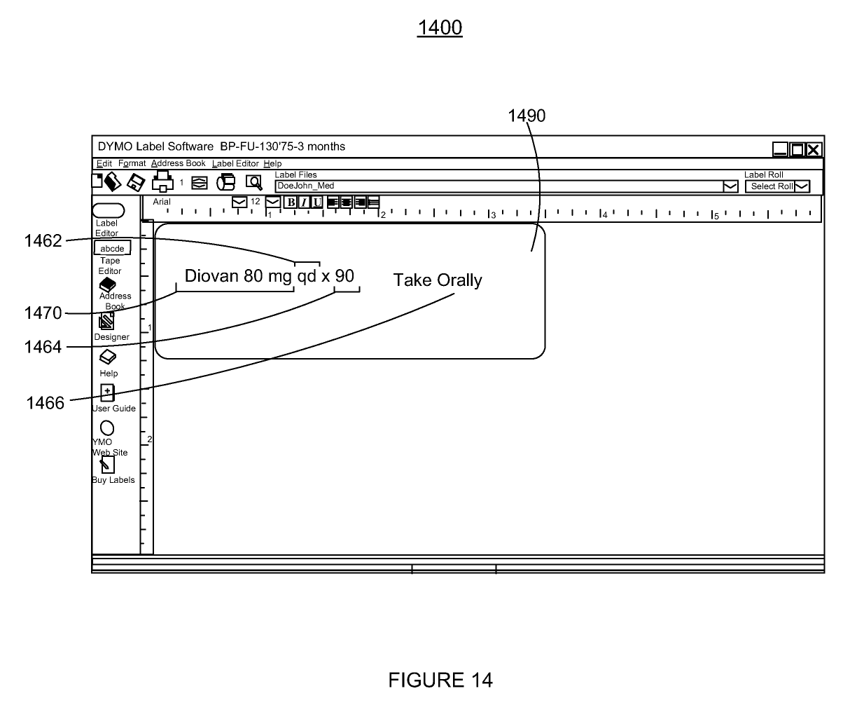

Referring to FIG. 14 there is illustrated an example screen shot 1400 of an interface displaying an initial prescription summary 1490, as may be generated by management module 146. This interface 1400 may be used by a medical practitioner to facilitate the input or modification of, for example, prescription records 600. In response to the selection of a prescription template 900 by a user at Block 220 management module 146 may be configured to generate and display an initial prescription summary 1490. This initial prescription summary 1490 may include data derived from the selected prescription template 900 and the management module 146 may display this data using, for example, editable graphical user interface elements such as editable text fields. For example, the frequency 1462, duration 1464, directions 1466 and description 1470 data fields of the illustrated initial assessment summary 1490 correspond with the frequency 962, duration 964 directions 966 and description 970 data fields of exemplary prescription template record 900A which Dr. Smith selected at Block 220 as discussed above. Using a terminal 114, 114′, 116 or 116′ a user may edit and modify the initial prescription summary 1490 that is displayed by management module 146. For example, Dr. Smith may use a doctor terminal 114, 114′ to edit the data fields of the prescription summary 1490 displayed by management module 146 in the exemplary interface 1400.

Referring to FIG. 18, there is illustrated another example screen shot 1800 of an interface displaying a completed prescription summary 1890 as may be generated by management module 146. Comparing FIG. 18 with FIG. 14 it will be clear that the completed prescription summary 1890 has many elements in common with the initial prescription summary 1490 (e.g. the frequency 1462, 1862, duration 1464, 1864, directions 1466, 1866, and description 1470, 1870 data fields are the same). This correspondence of data is expected where an initial prescription summary 1490, which may include from data derived from a prescription template 900, is used as the starting point for entering the specifics of a prescription as shown by completed prescription summary 1890. For example, using the initial prescription summary 1490 as a starting point Dr. Smith may use a doctor terminal 114′ 114′ to input specific details regarding John Doe's usage requirements for “Diovan” to treat his hypertension condition (e.g. that he is to be given a single refill 1868). Those skilled in the art will appreciate that various other methods for displaying and editing data in, for example, a prescription summary 1490 are possible in alternative embodiments and implementations and that the examples described are for illustrative purposes only.

After modification, data from the completed prescription summary 1890 may be saved in, for example, a prescription record 600 by, for example, the management module 146. Referring to FIG. 18 and FIG. 6, it is shown that the frequency 1862, duration 1864, directions 1866, repeat 1868 and date 1820 fields of a prescription summary 1890 may correspond, for example, with the frequency 662, duration 664, directions 666, repeat 670 and date 620 fields of an exemplary prescription data record 600A. It should also be noted that the name field 1824 “John Doe” may correspond with the name of the patient currently being assessed. Similarly, the date field 1820 may correspond with the date 420 of the patient's last assessment record 400A. It may therefore be understood that, for example, the patient record module 140 may be configured to automatically populate an initial prescription summary 1490 with the current date and the name of the patient currently being assessed. Alternatively, the date 1820 and name 1824 may be manually entered by a user. In alternate embodiments, data from the completed prescription summary 1890 may also be saved to, for example, the following: a patient information record 300; a patient assessment record 400; a patient assessment history record 500; and/or a billing data record 700. Finally, it may be noted that the prescription data record 600A comprises the prescription template identifier 660 “PT213”. This corresponds with the prescription template identifier 960 of exemplary prescription template record 900A. This correspondence is included in order to visually confirm that the prescription data record 600A was entered using the prescription template 900A.

The management module 146 may also be configured to create new prescription template records 900 using, for example, data entered by a user in a prescription summary 1490, 1890. For example, a user may start with a blank prescription summary (not shown) or an initial prescription summary 1490 based on an existing prescription template record 900. The blank or initial prescription summary 1490 may be generated, displayed and modified in a manner similar to that which is described above. However, instead of saving the data in the completed prescription summary 1890 to, for example, a prescription record 600 as described above, the management module 146 may be configured to save the data in a new prescription template record 900. In this manner new medical condition templates 900 can be added to system 100 for future use.

Templates may also be used to facilitate the entry of billing information. For example, an assessment template record 800 may also comprise a billing code identifier 880 which may match or otherwise correspond to a billing code identifier 1080 by, for example, comprising a foreign key. Those skilled in the art will appreciate that when a user selects (e.g. using a doctor or nurse terminal 114, 114′, 116, 116′) an assessment template 800 which has a corresponding billing code identifier 880 that, for example, patient record module 140 may be configured to use the billing code identifier 880 to reference a specific billing code 1000 and generate an initial billing summary (not shown). The initial billing summary may be used as the starting point for entering a completed patient billing record 700. The process for generating and using an initial billing summary may be substantially similar to the processes described above with respect to assessment summaries 1390 and prescription summaries 1490. In the alternative, where there is no billing code identifier 880 or the user does not select a billing template, for example, billing records 700 may be manually input by a user. It will be understood, by those skilled in the art, that the manual input of billing records 700 may be facilitated through the use of user interface elements such as drop down boxes, pick lists and check boxes, for example (see FIG. 12). The management module 146 may be configured to pre-populate these interface elements with data based on, for example, the data contained in the billing code records 1000.

At Block 224 an adhesive medical summary 1190 may be generated by the medical generator 152, for example, and then printed using the printer 112, which may alternatively be considered part of the medical generator 152. Referring briefly to FIG. 11, recall that an adhesive medical summary 1190 may comprise an adhesive medical history summary 1192, an adhesive medical assessment summary 1790, an adhesive prescription summary 1890 and/or an adhesive immunization summary (not shown). In one exemplary embodiment, the adhesive medical summary generation process at Block 224 may be initiated by a user via, for example, a nurse terminal 116, 116′ and the interface illustrated in FIG. 12. Specifically, a user may select the button 1250, for example, in order to trigger the generation of a medical summary. In response to the selection of button 1250 the output module 144 may be configured to query the patient database 160 for patient medical assessment information (e.g. as may be stored in assessment records 400), which it then transmits to the medical generator module 152. The medical generator module 152 may, for example, format the data received from the output module 144 and display a medical assessment summary print screen similar to the exemplary embodiment shown generally as 1700 on a nurse terminal 116,116′. A user may then opt to print the displayed medical summary 1790 by selecting, for example, the print button 1704. In response to the print button 1704 being selected the medical generator 152 may be configured to transmit the medical summary 1790 to a printer 112 using, for example, network 110. The printer 112 may then print the medical summary 1790 on, for example, single sided adhesive paper. Those skilled in the art will appreciate that other embodiments or variations of the adhesive medical summary generation process at Block 224 are possible depending on the configuration of system 100.

Those skilled in the art will appreciate that the generation of a specific adhesive medical summary 1190 may be performed as often as required, at any time and for any specific assessment date 420. This is possible because the data required to generate adhesive medical summaries 1190 is stored in a database (e.g. patient database 160) and may be accessed by a user at any time using a terminal 114, 114′, 116 or 116′ and the patient record module 140, for example. This means, for example, that if a patient's physical chart 1100 were to be destroyed, damaged or misplaced that a medical practitioner could use the output module 144 and medical generator 152, for example, to re-generate all the adhesive medical summaries 1190 for the physical chart 1100. By re-generating all the adhesive medical summaries 1190 a new copy of the physical patient chart 1100 could be constructed by, for example, chronologically affixing the adhesive medical summaries to new insert pages.

Returning to FIG. 2, at Block 226 the generated adhesive medical summary 1190 (e.g. in a specific embodiment this may include medical assessment summary 1790) may be affixed to the patient's physical chart 1100. In order to accomplish this the physical record 1100 may need to be retrieved from physical record storage 180. Once retrieved the adhesive medical summary 1190 may be affixed to the chart 1100. This may comprise affixing the summary 1190 to the cover of the chart 1100, or to a specific insert page in the chart 1100, for example. An orderly system for affixing medical summaries to the patient's physical record 1100 may be used. One example method of adhesive summary management is described below with respect to FIG. 11. For example, after completing the assessment of John Doe and entering the patient assessment information in accordance with Block 222, Dr. Smith may tell the nurse at the front desk to update John Doe's physical patient record 1100. The nurse may then use a nurse terminal 116, 116′ and the medical generator 152, for example, to create adhesive medical summaries 1190, which may correspond with at least some of the information entered by Dr. Smith at Block 222 and which can be affixed to John Doe's physical record 1100.

At Block 228 a determined prescription may be generated by, for example, the prescription generator 154 and printed using the printer 112. The process for generating a determined prescription may be similar to that discussed above with respect to the generation of adhesive medical summaries 1790 at Block 224. Furthermore, prescriptions may be printed on, for example, paper as opposed to adhesive stock. Once printed, a prescription may be given to a patient or a third party and/or affixed to the patient's physical record 1100.

Referring to FIG. 15, there is illustrated an example screen shot 1500 of a prescription print screen. A determined prescription for John Doe, as may be produced by prescription generator 154, is shown generally as 1590. When a user selects button 1252 (see FIG. 12) the screen shown generally as 1500 may be displayed by, for example, the output module 144 prior to printing. The prescription 1590 may comprise: the patient's name 1524, the date the prescription was made 1520; the type of drug or nature of the prescription 1560, the frequency 1562; the duration 1564; the directions for use 1566; and, the number of repeats 1570. The information shown in the screen shot 1500 corresponds with exemplary information in the prescription data record 600A and the prescription template record 900A. In addition to the above noted prescription details, the prescription will also typically comprise: a header 1550 specifying the prescribing doctors contact information; and, a digital signature 1552 of the prescribing doctor. For example, after completing the assessment of John Doe and entering the patient assessment information in accordance with Block 222, Dr. Smith may use a doctor terminal 114, 114′ and prescription generator 154, for example, to create a prescription 1590 which may correspond to at least some of the prescription information entered in Block 222. This prescription may be printed and given to John Doe so that he may obtain a prescription for Diovan to treat his hypertension. In an alternate embodiment the prescription information may be transmitted electronically using, for example, network 110 directly to a pharmacy for fulfillment. Those skilled in the art will appreciate that there may be many ways in which the prescription information may be used to fulfill a prescription either physically or electronically.

At Block 230 a billing invoice may be generated by, for example, the billing generator 156 and printed using the printer 112. The process for generating a billing invoice may be similar to that discussed above with respect to the generation of determined prescriptions 1590. A billing invoice may contain data for any number of patients for any time period. Once printed, a billing invoice may be given to a patient or a third party and/or affixed to the patient's physical record 1100. Billing invoices may also be submitted to third parties electronically using, for example, network 110. Those skilled in the art will appreciate that there may be many methods and formats for submitting billing invoices to third parties either physically or electronically.

Referring to FIG. 16, there is illustrated an exemplary billing summary shown generally as 1600 as may be generated by the billing generator 156. The billing summary 1600 has been run for a specified date 1620 and contains billing information for all encounters (e.g. assessments) billed for that date 1620. Specifically, the data shown corresponds to the exemplary billing records 700A, 700B and 700C for the date 720 of Oct. 15, 2009. For example, the patient identifier 1610 corresponds with the patient identifier 710. This patient identifier 710 may also allow the system 100 to retrieve the insurance identifier 1622 and the patient's name 1624 from the corresponding patient information records 300 (e.g. using a foreign key lookup). The billing code 1680 and description 1628 correspond with the exemplary billing data record fields 780 and 724 respectively. Furthermore, as discussed above, a billing record 700 may correspond with a billing code using the billing code field 780. Using the billing code field 780 the patient record module 140 may be configured to retrieve data from, for example, the remarks field 1086 of the billing code records 1000 and display it as remarks column 1686.

After the adhesive medical summaries 1190 (e.g. 1192, 1790 and 1890), prescriptions 1590, and billing summaries 1600 have been affixed to the patient's physical record 1100 it may be returned to physical patient record storage 180. In an alternate embodiment the billing summaries 1600 may be stored separately from the patient's physical record 1100.

Referring now to FIG. 11, there is illustrated an example representation of a physical patient record shown generally as 1100. As previously described, this patient chart 1100 may be stored in physical patient record storage 180. The example physical chart 1100 is comprised of: a containing cover 1102 which may comprise a file folder, binder or book, for example; and, multiple page inserts 1150, 1150′ and 1150″ which may comprise standard sheets of paper, for example. The chart cover 1102 may comprise a chart label 1112 that identifies the patient using their name 1124″ and/or a unique patient identifier 1110.

As discussed above, the electronic assessment history records 500 may be used to facilitate patient care by providing a medical practitioner with an up to date picture of a patient's current medical conditions. Furthermore, the adhesive medical summaries 1190 generated by the output module 144 may comprise an adhesive medical history summary 1192. By affixing the adhesive medical history summary 1192 to the inside of cover 1102 of the physical chart 1100, for example, an up to date medical condition history is maintained in the physical patient record 1100. Specifically, if there is an update to the electronic medical history records 500 a new adhesive medical history summary 1192 may be generated and affixed to the chart 1100. Typically the current history summary 1192 will be used to obscure any previous history summaries 1192 affixed to the chart. The data fields of the exemplary medical history summary 1192 shown in FIG. 11 generally correspond with the assessment history records 500.

As described, the physical chart 1100 may comprise many insert pages 1150. These pages may be used to keep a historical record of a patient's assessments. Specifically, when an assessment is performed and, for example, the assessment records 400, prescription records 600 and billing records 700 are updated adhesive medical summaries 1190 including, for example, an adhesive medical assessment summary 1790 may be generated and affixed to the physical patient record 1100. In an example management scheme more than one medical assessment summary 1790 may be affixed to an insert page 1150, and the insert pages may form an assessment stack 1106. When an insert page becomes full a new insert page 1150 may be added to the front of the assessment stack 1106. In this manner, the most recent patient assessment pages 1150 are maintained at the front of the stack 1106, and a full chronological listing of prior assessments (e.g. 1150′, 1150″) are maintained towards the back of the stack 1106. As described above, an adhesive medical summary 1190 may also comprise an adhesive prescription summary 1890 which may also be affixed to the physical chart in a manner similar to that which is described above with respect to adhesive medical assessment summaries 1790. In the embodiment shown the medical and prescription summaries are managed in the physical chart 1100 using a two-column system with medical assessment summaries 1790 being affixed to the left hand side of an insert page and prescription summaries 1890 being affixed to the right hand side of the page. Alternative arrangements for affixing the adhesive summaries and managing insert pages are clearly possible. For example, if an adhesive immunization summary was commonly generated, a three column approach could be used (e.g. with the third column being used for adhesive immunization summaries).

The data fields of the adhesive medical assessment summary 1790 may correspond with those discussed above with respect to FIGS. 13 and 17 and the example electronic medical assessment summaries 1390, 1790. Similarly, the data fields of the adhesive prescription summary 1890 may correspond with those discussed above with respect to FIGS. 14 and 18 and the example electronic prescription summaries 1490, 1890.

As discussed above, a physical copy of the determined prescription 1590 may also be attached to the physical patient record 1100. In the embodiment shown the determined prescription 1590 has been affixed to the most recent page insert 1150 using a paperclip 1108. Though not shown, the physical patient record 1100 may also be used to store copies of billing summaries 1600.

It will be understood by persons skilled in the art that the features of the user interfaces illustrated with reference to the example screenshots, templates, lists and layouts described herein are provided by way of example only. It will be understood by persons skilled in the art that variations are possible in variant implementations and embodiments.

The steps of a method in accordance with any of the embodiments described herein may be provided as executable software instructions stored on computer-readable media, which may include transmission-type media. Such steps may not be required to be performed in any particular order, whether or not such steps are described in claims or otherwise in numbered or lettered paragraphs.

The invention has been described with regard to a number of embodiments. However, it will be understood by persons skilled in the art that other and modifications may be made without departing from the scope of the invention as defined in the claims appended hereto.

What is claimed is:

1. A method for managing patient information comprising:
(a) storing patient medical information in an electronic patient record;
(b) generating at least one adhesive medical summary corresponding to the patient medical information; and
(c) affixing the adhesive medical summary to a physical patient record.

2. The method of claim 1 further comprising:
(d) determining the patient medical information through an assessment.

3. The method of claim 2 wherein the assessment comprises an examination of a patient.

4. The method of claim 1 further comprising:
(d) generating a billing summary corresponding to the patient medical information.

5. The method of claim 1 further comprising:
(d) storing a set of at least one medical condition template, wherein storing patient medical information comprises selecting at least one medical condition template from the set.

6. The method of claim 5 further comprising:
(e) storing a set of at least one billing code, wherein at least one billing code in the set corresponds to at least one medical condition template.

7. The method of claim 6 further comprising:
(f) selecting a billing code corresponding to the patient medical information; and
(g) generating a billing summary corresponding to the selected billing code.

8. The method of claim 1 wherein the patient medical information comprises at least one determined prescription.

9. The method of claim 8 further comprising:
generating the at least one determined prescription.

10. The method of claim 5 further comprising:
storing a set of at least one prescription template, wherein storing patient medical information comprises selecting at least one prescription template.

11. The method of claim 10 further comprising associating at least one prescription template with at least one medical condition template.

12. The physical patient record produced by the method of claim 1.

13. A system for managing patient medical information comprising:
(a) an electronic patient record database comprising at least one electronic patient record containing patient medical information; and
(b) a medical summary generator operatively coupled to the electronic patient record database, and configured to generate at least one adhesive medical summary corresponding to the patient medical information.

14. The system of claim 13 further comprising:
at least one physical patient record to which the at least one adhesive medical summary may be affixed.

15. The system of claim 14 further comprising:
a stored set of at least one medical condition template, wherein each medical condition template in the set may be used to input patient medical information.

16. The system of claim 15 further comprising a stored set of at least one billing code.

17. The system of claim 16 further comprising a billing generator operatively coupled to the electronic patient record database and configured to generate billing summaries corresponding to at least one billing code.

18. The system of claim 17 wherein at least one billing code corresponds to at least one medical condition template.

19. The system of claim 13 wherein the patient medical information comprises at least one determined prescription.

20. The system of claim 19 further comprising a prescription generator operatively coupled to the electronic patient record database and configured to generate the at least one determined prescription.

21. The system of claim 15 further comprising:
a stored set of at least one prescription template, wherein each prescription template may be used to input patient medical information.

22. The system of claim 21 wherein at least one prescription template corresponds to at least one medical condition template.
